(19) United States
(12) Patent Application Publication
(10) Pub. No.: US 2007/0071971 A1
(43) Pub. Date: Mar. 29, 2007

(54) System and method for erasable highlighting film

(76) Inventor: Carolyn Drogan, Sarasota, FL (US)

Correspondence Address: Carolyn Drogan, 8466 N. Lockwood Ridge Rd., Sarasota, FL, 34243, US

(21) Appl. No.: 11/607,765

(22) Filed: Nov. 30, 2006

Related U.S. Application Data
(63) Continuation-in-part of application No. 11/010,926, filed on Dec. 13, 2004, now abandoned.

(51) Int. Cl. B32B 7/12

(52) U.S. Cl. 428/343; 428/355 RA

(57) ABSTRACT

Flat, or folded, colored and colorless, erasable highlighting sheet film, with options for pre-scored, pre-cut, perforated strip-lined, flat, folded, pocketed, adhesive and no tack versions, the method and apparatus of which are used for short and/or long term affixation of the highlighting sheet film to a substrate, and removal thereof at any time. During use, the sheet film protects the associated substrate and after removal preserves the privacy of personal notes, while optionally saving them for sharing with others in association with the same or duplicate substrate. In addition, the sheet film may be saved, indefinitely stored, cleaned, and/or reapplied without visible damage to any substrate. Optional apparatus used to provide a second layer/level/echelon of highlighting to the sheet film, or otherwise prepare it for use or reuse, include colored or colorless marking tools, cloth, adhesive means, templates, and/or cutting tools in varying combinations, but not limited to these combinations.

### CROSS-REFERENCES TO RELATED APPLICATIONS

This application relates to currently depending U.S. utility patent application 11/010926 filed by the same inventor for substantially the same subject matter on Dec. 13, 2004, whereby the inventor herein claims all benefit from the earlier application.

### BACKGROUND

1. Field of the Invention

This invention relates to methods and apparatus used to removably highlight text, other printed material, and other items such as but not limited to signs, specifically to a kit including one or more transparent and translucent visually and/or optically clear, colored, clear-colored, clear colorless removable highlighting sheet film with erasable feature that when applied to a surface makes the covered portion of the surface visually enhanced and immediately noticeable at a glance, whether as a result of colored sheet film providing a first layer/level/echelon of highlighting, or when colorless and/or colored sheet film is to provide a second layer/level/echelon of highlighting. The sheets may be left on most surfaces indefinitely and are easily, effectively, and completely removed from most surfaces without damaging them, without making any visible alteration thereto, without permanently altering the integrity of, and without devaluing the surface of the substance/material to which it had been applied. Also, the sheet film are adapted for the erasable receipt of markings that include printing markings, written notes, designs, symbols, artwork, stickers, decals, and/or other personalized informational markings which cause a person's attention to be drawn to a passage in a book or a portion of any larger surface or object such as but not limited to an industrial sign used for enhancing workplace safety.

The present invention relates to means used for highlighting preferred sections of text, other printed material, and other objects, specifically the present invention provides a user highlighting sheet film in a variety of pre-formed and pre-sized and continuous film models, including flat, flat foldable, flat-folded, and pre-pocketed sheet film that may be used in their entirety or further sized into smaller pieces and/or reconfigured to fit alternative sizes and applications such as formed into larger sheets and strips to cover larger areas not found in a kit package. The present invention sheet film is typically transparent or translucent for the accentuation or highlighting of the material/substrate/surface/object but may also be opaque to highlight subject matter surrounding areas blocked out by the present invention. As an option highlighting by blocking out unneeded areas may be accomplished by use of a release lining associated with the present invention highlighting sheet film. The highlighting system, methods and apparatus of the present invention are adapted for highlighting a variety of materials and are not limited to textbooks, unbound manuscript pages, and single sheets of paper. In the present invention, removable highlighting sheet film with erasable feature is used in association with a wide variety of printed and non-printed substrates not limited to paper such as but not limited to illustrations, charts, tables, signs, display boards, and screens, display screens, display boards, telephone books, calendars, drawings, research materials, artwork, pictures, paintings, floors, walls, and/or painted surfaces, to highlight and/or accentuate them in their entirety, or selected/preferred sections thereof. The highlighting sheet film provides models that may be left on surfaces indefinitely without damage to substrate without making any visible alteration thereto, without permanently altering the integrity of, and without devaluing the surface of the substance/material/substrate/object to which it had been applied. Multiple forms of film/substrate association are contemplated, very-low tack and no-tack included, none of which will damage the substrate upon sheet film removal. The sheet film of the present invention may be used alone to provide a first layer/level/echelon of highlighting, but also has the capability of accepting a removable/erasable second layer/level/echelon of highlighting substance/material compatible with the films intended use and applied marking tool, such as but not limited to a device later referred to hereinafter as a kit pen. whose marked lines may be erased. When a second layer/level/echelon of highlighting is desired with both the first and second layers/levels/echelons of highlighting providing visual clarity for viewing of the associated substrate. In addition to highlighting printed text found in books, and other printed material, and non-printed substrates, methods and applications of the present invention involve the use of sheet film that may be easily applied, removed, and reapplied multiple times, without visible substrate alteration or devaluation in the vast majority of substrates to which it is applied, including the discoloration or distortion of paper. Further, the present invention highlighting sheet film acts as a protective layer for the substrate to which it is applied. The present invention is also versatile and convenient in its application, easy to apply and remove, as well as save, clean and reuse, and/or reconfigure. Thus the life of the present invention sheet film can be extended, as well as the life of the substrates to which it is applied are also extended as a result of being protected by the overlaying sheet film, or sheet film can be discarded after one use. The present invention sheet film further provides accentuating, writing, and designing benefits not available/achievable with conventional highlighting markers, such as but not limited to the option of making permanent and/or temporary markings that may be removable from present invention sheet film, from virtually every substrate and without damage to the substrate and making present invention reusable methods of adhesion such as the formation of pockets to cover two sides by folding and/or sealing one or more pieces of present invention highlighting sheet film. When present invention sheet film is formed into a pocketed embodiment, it can be sealed during its manufacture to provide one or more closed ends, or be configured by folding and/or sealed by the user. Pocket models are applied to a substrate by wrapping it around a portion or all of a substrate area, and/or by insertion of a substrate or by peeling open and laying it against the surface to be accentuated or highlighted such as but not limited to a page in a book, or a selection of pages in a book or notebook, needed for example but not limited to student review. Another feature advantage of the present invention highlighting sheet film is its ease in creating instant tabs for identification by folding sheet film or placing self-adhering highlighting sheet film pieces together and/or sealing as to provide closed ends preferably leaving a portion extending beyond at least one substrate edge it envelops. It is contemplated for the present invention sheet film to be capable of accepting user markings made with one or more types of highlighting instruments/‘kit pen’ since one option for its sale is in a package with one or more pieces of sheet film. Kit pens compatible with the films intended use/structure may be configured for providing colored and colorless, temporary and/or permanent, pressure-sensitive or not, and highlighting markings to the present invention sheet film. Highlighting, highlighted, and handwritten and printed markings made to present invention sheet film may be preserved for future referencing by the user or others. In the alternative, highlighted sheet film may be removed from a substrate to keep highlighted subject matter including personal highlighting markings made to film covering areas of interest private, after which sheet film may be reapplied for personal review by the original user, and/or optionally may be passed along to others for shared-viewing once reapplied to similar substrates, or marked film may be erased, reused, reconfigured, and/or discarded

The present invention sheet film can be repeatedly applied and removed from the same position on a book, page or other item or surface without damaging or visibly altering the book or surface, or the sheet film. When one reads the following invention description, one will understand that the present invention sheet film can be employed in many more applications, and only a few have been provided here by way of example.

Thus, it provides an excellent study aid for students whereby they can quickly and easily mark both sides of an entire page, group portions of pages in a book that have not yet been committed to memory, easily locate marked information or a selected marked or unmarked item within a book or grouping of pages, add highlighting notes where needed to the exposed surface of the highlighting sheet film so as to provide a second layer/level/echelon of highlighting and thereby bring in additional information for association with the generally highlighted page/illustration/text/grouping while also allowing all highlighting markings and notation to be instantly removed and/or replaced by other highlighting markings and notation as one commits certain portions of the highlighted information to memory, and remove any markings notes on the pocket, and/or remove the entire pocket or readjust the number of pages in the grouping it surrounds, when the student determines that the highlighted information is learned and no longer needs an easy distinguishing reference.

Household, commercial, and industrial users of the present invention may find differing sizes and forms of the present invention convenient to use. It can be used as a study aid, wherein a student can accentuate entire pages or group portions of them that have not yet been committed to memory (the previously explained pocketed configuration is easy and convenient for such accentuation or highlighting), used for easy location of the information or item within a book or other grouping of pages that one expects will need frequent/repeated review, used to add notes to the exposed surface of the sheets where needed for inclusion of additional information, and then used to erase the notes and/or remove the sheets when the information highlighted is learned and no longer needs an easy distinguishing reference.

Thus, it is contemplated for the present invention sheet film to be available to users in the form of pre-sized and/or continuous. Sheet film dispensed pre-sectioned or pre-formed film models as individual/single pre-sized sheets, and/or may be continuous dispensed fan-folded, or from a roll. Pre-sectioned pre-sized sheet film having pre-cut strips, can be variable in shape and size may also be determined by the end consumer. Sheet film of the present invention may also include/provide sheets optionally cut into strips, blocks, and other geometric shapes, and/or non-geometric configurations that are attached to sheet backing/liner, wherein the sheet backing/liner is also used for highlighting purposes or made a temporary part of a sheet until separated for use and is usable and reusable so as not to involve any waste, and/or sheets that will be cut and sized, or otherwise subdivided according to user need., resized by cutting and/or folding, separating by tearing, perforation, and break-away and/or peeling and any other method of reconfiguring or resizing sheet film models for the same or other application, or may be disposed/discarded. Sheet film and any subdivided portions thereof may be pre-scored, and/or perforated or not, with sheets manufactured to cover large areas, such as but not limited to long paragraphs, the text on an entire page in a book, large pictorials, paintings, signs, logos, and the like. In addition, the sheet film of the present invention when clear may highlight areas of interest while simultaneously identifying the section. When colored sheet film is utilized to highlight entire pages at one time instantly, a colored indexing system can be created. As a part of a precolored and colorless indexing system, tabs may be marked with or by a kit pen to provide a second layer/level/echelon of highlighting. Thus, the present invention provides for highlighting portions of text, other printed material, and other objects to be made optically noticeable for easy visual reference at a glance, and when accentuation is no longer needed, it is safely and effectively removed without damage to the intended substrate or the sheet film.

Additional options for present invention sheet film reconfiguration include peeling and/or reverse creasing folded and pocket models to fit two self-facing adjacent or parallel surfaces, and/or cutting, in combination with or separate from the peeling, separating, cutting, releasing, and/or tearing of scored, pre-scored, perforated, release lined, release strip-lined, and/or break-away models. Further, present invention sheet film may be placed vertically and alternately across the width of a bound or unbound sheet, and other substrates or multiple pieces of present invention sheet film can in combination be easily used to cover a large area, such as but not limited to a map. Although not limited thereto, use of the present invention sheet film is contemplated on surfaces that contain/include paper, vinyl, cloth, plastic, wood, porcelain, metal, glass, stone, and/or composites thereof, as well as for highlighting book pages, entire sentences or parts thereof, paragraphs, pictorials, text not in book form, logos, drawings, artwork, paintings, signs, floors, walls, and painted surfaces. Further, applications of the present invention sheet film may include, but are not limited thereto, use by teachers for repeated and varied highlighting of instructional or archival materials for different applications or use by different student groups, use by students as a study aid in preparation for exams, and/or for preserving handwritten and highlighting markings and otherwise printed and non-printed material on film for future reference and keeping personal notations private, use in commercial establishments to make defining lines on walls and floors to highlight and/or draw attention to existing signs, and use in industry to accentuate safety and directional information such as, but not limited to, “hazard”, or ‘warning “deep”waters’, with the ability to periodically vary the accentuation to maintain viewer interest and attention and/or be updated as needed to correspond to current safety programs or concerns; use to plot a travel route on a map and removal after the trip for plotting other trips on the same map to different destinations at a later time, or calendar for which a schedule for one or more persons is required each may have their own overlay. Alternative daily use of the present invention sheets can be in association with calendars, television and computer screens, and note boards.

When folded, and/or pocket models the present invention sheet film can be used to cover one or both sides of a sheet, such as a page in a book. In the alternative, folded and/or pocketed sheet film may be wrapped around single or multiple pages, wherein when the wrapped sheet film is configured to provide tab/indexing, sections/chapters can be instantly marked according to color and/or by the marking of colorless present invention sheet film via one or more kit pens.

The present invention also may include a marking means compatible with the sheet film that allows legible erasable markings to be made thereon, subsequently removed as needed, and then reapplied numerous times as the sheet film is reused. Although not limited thereto, markings may be in the form of applied markings, or markings that become visible as pressure is applied (hereinafter referred to by the words etched markings), similar to the children's toys which allow stylus marking on a screen to make lines and images without ink. Pressure may cause any type of visual change, such as but not limited to darkening, lightening, or the appearance of a distinguishing color. Further, applied markings may be saved to the substrate, or removed and stored for future referencing and/or passed on to others who share the same documentation or subject matter. Once removed from a substrate, the highlighting it provided becomes cryptic and private. Reapplication of a piece of present invention highlighting sheet film over the subject matter targeted for highlighting allows the highlighted markings to be revealed for re-viewing. In the alternative, instead of immediate reapplication without alteration, any piece of present invention sheet film may be cleaned, subdivided, and/or reconfigured or otherwise prepared for reuse in the same or similar application, or for a different application, or it may be discarded and never reused.

The mounting means used to attach pieces of present invention sheet film to the surfaces targeted for highlighting can include light adhesive, electrostatic means, folded and wrapped and/or tucked, and pocketed sheet film models, or a combination thereof. Additional features of the present invention sheet film that assist in preserving a selected application of highlighting sheet film to a substrate for continued use in a designated location, include but are not limited to, punched holes, a tucked configuration involving the binding edge of the page it surrounds, and creasing. further, placing the present invention sheet film into a selected location of use may involve adhesive or other mounting means employed on one or both sides, with adhesive or other mounting means on two sides that allow the sheet film to be inserted between two surfaces, or positioned around one or more surfaces so as to maintain/adhere such surfaces together while accentuating a portion or all of them. Use of present invention colored sheet film to secure at least two sheets together can also accentuate a portion or all of them by varying the color of the light passing collectively through all or a part of them. It is contemplated for any adhesive or other mounting means used for placing the present invention sheet film into a selected location to allow the substrate below it to be viewed without obstruction. While the present invention can be pre-manufactured to innately carry an electrostatic charge, dispensing or other apparatus may also be used to apply the charge to the film prior to actual application.

Additional other options in a present invention highlighting sheet film system, method and apparatus include but are not limited to, one or more colored and/or colorless marking instruments referred herein as a kit pen, one or more pieces of cloth adapted for cleaning and/or for surface preparation of sheet film to include erasure of applied markings applied to the exposed surface of sheets and/or creating an electrostatic charge, one or more cutting instruments, one or more templates with suggested cutting patterns for maximizing use of the present invention sheet film and/or adapted for storage of new and used sheet film, adhesive/mounting means adapted for temporary or permanent affixation without permanent substrate alteration, and combinations thereof that allow marked or unmarked present invention sheet film to be saved and/or stored and reapplied for future use/referencing, and/or passed along to others who may share the same printed material or subject matter, and also allow markings to be removed from sheet film to return it to its original condition. Although it is contemplated for present invention sheet film to be reused for one or more times in the same and/or different highlighting application, it also may be discarded at any time. Other provided optional features of the present invention sheet film further include manufacture from pH balanced/neutral materials for archival and other applications, a top and/or bottom surface capable of accepted applied highlighted markings and other personalized informational markings optionally provided by use of a colored and/or colorless kit pen, pre-sectioned sheet film with or without a releasable backing that protects or preserves the light adhesive and/or electrostatic charge prior to use or repeat use sheet film pre-formed as a pocket, sheet film with visualization enhancements, color light reflecting capability, sheet film with light absorbing capability, sheet film with light refracting capability, sheet film with polarizing capability, sheet film with magnifying capability, disposable sheet film configured for one-time use, and reusable sheet film configured for use multiple times, providing sheet film cut into one or more pre-sized pieces, providing sheet film in a continuous length on a roll that can be cut or otherwise subdivided for customized highlighting use and for use on large items or objects, providing pre-cut and/or pre-scored and/or strip release lined pieces of sheet film, providing sheet film with perforated markings that assist in user creation of customized sizes, and providing sheet film with pre-cut, perforated, and/or pre-scored markings that assist in user creation of customized sizes appropriate to an intended application via user separation/cutting a desired length from any of the provided pre-cut, pre-scored, and perforated film pieces, and/or by user folding and/or sealing to create a closed end in any piece of sheet film to form a pocket. Further, erasure of the applied markings in a second layer/level/echelon of highlighting on sheet film, cleaning its exposed surface, or otherwise preparing present invention sheet film for reuse is not limited by use of cloth alone, and can be by separating two pieces of highlighting sheet film having etched markings, or any compatible.

The present invention relates to means used for highlighting printed text, specifically the present invention provides a user with reusable highlighting sheet film in a variety of pre-formed and pre-sized film models, including flat, flat foldable, flat-folded, and pre-pocketed sheet film models that may be used in their entirety or further sized into smaller pieces and/or reconfigured to fit alternative applications. The present invention sheet film is typically transparent or translucent for the accentuation of the surface/object below it, but may also be opaque to highlight subject matter surrounding areas blocked out by the present invention. In the alternative and as an option, highlighting/accentuation by blocking out unneeded areas may be accomplished by use of a release liner associated with the present invention highlighting sheet film, thus making use of the entire present invention sheet film model and eliminating waste. The highlighting system, methods and apparatus of the present invention are adapted for highlighting a variety of materials, and are not limited to textbooks, unbound manuscript pages, and single sheets of paper. In the present invention removable/reusable highlighting sheet film is used in association with a wide variety of printed and non-printed substrates, such as but not limited to illustrations, charts, tables, signs, computer screens, telephone books, maps, calendars, drawings, research materials, artwork, paintings, floors, walls, pictures, and/or painted surfaces, to highlight and/or accentuate them in their entirety, or selected/preferred sections thereof. The highlighting sheet film of the present invention may be left on most surfaces indefinitely without damaging them, without making any visible alteration thereto, without permanently altering the integrity of, and without devaluing the surface of the substance/material/substrate/object to which it had been applied. Multiple forms of film/substrate association are contemplated, low tack and no-tack included, none of which will damage the substrate upon sheet film removal. The sheet film of the present invention may be used alone to provide a first layer/level/echelon of highlighting, but also has the capability of accepting a removable second layer/level/echelon of highlighting applied via a marking tool, such as but not limited to a device later referred herein to as a kit pen. The marking tool may apply color to colorless sheet film, contrasting color to pre-colored sheet film, and/or markings that appear after the application of pressure to sheet film (hereinafter referred to as ‘etched’ markings), including colored etched markings.

In addition to highlighting text and other substrates, methods and applications of the present invention involve the use of sheet film that may be easily applied, removed, and re-applied multiple times, without visible substrate alteration or devaluation in the vast majority of substrates to which it is applied, including the discoloration and/or distortion of paper. It also must be compatible with a marking instrument when a second layer/level/echelon of highlighting is desired, with both the first and second layers/levels/echelons of highlighting providing visual clarity for viewing of the associated substrate, unless highlighting is achieved via ‘blocking out’ for enhancement of surrounding areas. Further, the present invention highlighting sheet film provides a protective layer for the substrate to which it is applied. The present invention is also versatile and convenient in its application, easy to apply and remove, as well as save, clean and reuse, and/or reconfigure and reuse. Thus, the present invention sheet film can be discarded after one use, or the useful life of the present invention sheet film can be extended for additional use, while the life of the substrates to which it is applied are also extended as a result of being protected by the overlaying sheet film. The present invention sheet film further provides accentuating, writing, and designing benefits not available/achievable with conventional highlighting markers, such as but not limited to the formation of sheet film pockets. When present invention sheet film is formed into a pocket, it can be sealed during its manufacture to provide one or more closed ends, or the present invention sheet film can be folded into a pocketed configuration by the user. Pockets are applied to a substrate by wrapping it around a portion or all of a substrate area, such as but not limited to a page in a book, or a selection of pages in a book or notebook needed for student review. Another advantage of the present invention highlighting sheet film is its ease in creating instant tabs for a color indexing system capable of identifying areas or sections of significant interest by folding sheet film larger than the substrate area around it while preferably leaving a portion of the wrapped sheet film extending beyond at least one substrate edge, or employing two or more pieces of present invention highlighting sheet film together in a similar manner. It is contemplated for the present invention sheet film to be capable of accepting user markings made with one or more types of tool or instrument, hereinafter referred to as a second layer/level/echelon of markings, with the marking tools/instruments also referred to herein by the term ‘kit pen’, as one option for its distribution is in a package with one or more pieces of present invention highlighting sheet film. Kit pens may be configured for providing handwritten highlighting markings to the present invention sheet film that include but not limited to markings that provide accentuation via the use of color alone, markings that provide accentuation via contrast not involving color, temporary/erasable markings when sheet film is intended for reuse, permanent markings, markings that appear as a result of the application of pressure, and markings that are not pressure-sensitive. Handwritten highlighting markings on present invention sheet film may be preserved for future referencing by the user and/or others with the same or similar substrates. In the alternative, highlighted sheet film may be removed from a substrate to keep personal highlighted markings or areas of interest private, after which sheet film with personal notes may be reapplied for review by the original user, and/or optionally passed on to others for viewing similar substrates, or it may be erased, cut, and/or resized for other application, or discarded. Household, commercial, and industrial users of the present invention may find differing sizes and forms of the present invention convenient to use. Thus, it is contemplated for the present invention sheet film to be available to users in the form of pre-sized sheets, fan-folded sheets, and/or a continuous length dispensed in sheet form from a roll the dispensed length of which may be pre-sized via pre-scored or perforated markings, or user-determined, sheets comprising individually releasable pre-cut strips, or variable sizes created/determined by the end consumer. Sheet film of the present invention may also include sheets optionally cut into strips, geometric shapes, and/or non-geometric configurations that are attached to a liner or sheet backing, wherein the liner or sheet backing is also used for highlighting purposes (perhaps transparent or translucent for accentuation or opaque for blocking out unwanted areas to highlight surrounding subject matter) so as not to involve any waste, or made a temporary part of a sheet until separated for use, and/or sheets that will be cut for custom sizing, or otherwise subdivided according to user need. Sheet film and any subdivided portions thereof may be pre-scored, and/or perforated or not, with sheets manufactured to cover large areas, such as but not limited to long paragraphs, the text on an entire page in a book, large pictorials, paintings, signs, maps, business logos, and the like. In addition, the sheet film of the present invention when clear may highlight areas of interest while simultaneously identifying a grouping or section of sheets or pages of interest. For example, when colored sheet film is utilized to highlight entire pages at once, a colored indexing system can be created. As a part of a colored indexing system, tabs maybe marked with or by a kit pen to provide a second layer/level/echelon of highlighting. Thus, the present invention provides sheet film for highlighting portions of text, other printed material, and other objects needing to be made optically noticeable for easy visual reference at a glance, and when accentuation is no longer needed, it is safely and effectively removed without visible damage to the intended substrate or itself. The present invention sheet film forms of adhesion may include low tack and/or very-low tack adhesive, and/or no tack adhesion methods. Further, the most preferred embodiments of the present invention sheet film includes clear, colored, clear-colored, clear-colorless sheet film, and custom sizing options whereby manufacturer or user separation and/or cutting creates a desired size/strip/shape from pre-formed, pre-cut, pre-scored, and perforated film pieces, and the folding and/or sealing one or more sides of the sheet film creates pocketing options, as well as other options for present invention distribution and use that include but are not limited to use of a cloth adapted for creating temporary electrostatic sheet film adhesion without tack, at least one kit pen for making/associating a second layer/level/echelon of temporary or permanent highlighted markings with present invention sheet film, cleaner to prepare present invention sheet film for additional use, adhesive for user application to one or both highlighting sheet film surfaces to add adhesive to no tack sheet film or refresh existing tack, one or more templates adapted to assist user sizing of present invention highlighting sheet film and/or determining useful configurations, and at least one cutting instrument.

Among the following are things the present invention highlighting sheet film can do to a page, although there is more that it does to a page than is listed here, with further examples being identified and explained in subsequent sections of this disclosure. When folded, the present invention sheet film can be used to cover one or both sides of a sheet, such as a page in a book. In the alternative, folded and/or pocketed sheet film (with pockets comprising at least one side, edge or portion thereof being sealed) may be wrapped around single or multiple pages, wherein when the wrapped sheet film is configured to provide tab/indexing, sections/chapters can be instantly marked according to color by colored sheet film and/or by the marking of colorless present invention sheet film via one or more kit pens to provide a second layer/level/echelon of highlighting distinguishable by color or appearing as a result of pressure application. Thus, present invention highlighting sheet film provides an excellent study aid for students whereby they can quickly and easily mark both sides of an entire page, group portions of pages in a book that have not yet been committed to memory, easily locate marked information or a selected marked or unmarked item within a book or grouping of pages, add notes where needed to the exposed surface of the sheet film so as to provide a second layer/level/echelon of highlighting and thereby bring in additional information for association with the generally highlighted page/illustration/text/grouping while also allowing all highlighting and notation to be instantly removed and/or replaced by other highlighting and notation as one commits certain portions of the highlighted information to memory, and remove any notes on the pocket, and/or remove the entire pocket or readjust the number of pages in the grouping it surrounds, when the student determines that the highlighted information on one or more pages is learned and no longer needs an easy distinguishing reference. Additional options for present invention sheet film reconfiguration include reverse creasing folded and pocket models to fit two self-facing adjacent or parallel surfaces, in combination with or separate from the peeling, separating, cutting, releasing, and/or tearing of scored, pre-scored, perforated, release lined, release strip-lined, die cut, and/or break-away models. Further, present invention sheet film orientation is not restricted, and it may be placed vertically and alternately across the width of a bound or unbound sheet, and/or multiple pieces of present invention sheet film can be easily used in combination to cover a large area, such as but not limited to a commercial sign or map. Although not limited thereto, use of the present invention sheet film is contemplated on surfaces that contain/include paper, cloth, vinyl, glass, plastic, metal, stone, and/or composites thereof, as well as for highlighting book pages, entire sentences or parts thereof, paragraphs, pictorials, text not in book form, logos, drawings, artwork, paintings, signs, maps, floors, walls, and painted surfaces. Further, applications of the present invention sheet film may include, but are not limited thereto, use by teachers for repeated and varied highlighting of instructional or archival materials for different applications and/or use by different student groups, use by students as a study aid in preparation for exams wherein handwritten and highlighting markings are preserved for future reference but removable from the substrate at any time to keep personal notations private, use in commercial establishments to make defining lines on walls and floors to highlight and/or draw attention to existing signs or portions thereof, and use in industry to accentuate safety and directional information such as, but not limited to, “hazard”, or a warning about “deep water”, with the ability to periodically vary the accentuation to maintain viewer interest and attention and/or be updated as needed to correspond to current safety programs or concerns without the expense of sign replacement; use to plot one or more travel routes on a map and subsequent cleaning/removal of such routes after a trip so that other travel routes may be later plotted on the same map to different destinations, or use in an office with a calendar employed for planning/recording the monthly/quarterly schedules of one or more persons wherein each person may have their own overlay and changes can be readily updated as often as required. In the alternative, daily use of the present invention sheet film may be in association with calendars, television and computer screens, and/or note boards.

Although this invention relates to methods and apparatus used to removably highlight text, other printed material, and other items such as but not limited to signs, distribution of the present invention sheet film may be provided as a kit in a package with one or more items capable of cleaning, refreshing, changing, and/or enhancing its use. Specifically a kit or package containing one or more pieces of clear, colored, clear-colored, clear colorless, or transparent clear visually transparent or translucent colored and colorless erasable highlighting sheet film that when applied to a surface makes the covered portion of the surface visually enhanced and immediately noticeable at a glance, whether as a result of colored sheet film providing a first layer/level/echelon of highlighting, or when colorless and/or colored sheet film is further marked to provide a second layer/level/echelon of highlighting. Present invention sheet film may be left on most surfaces indefinitely and is easily, effectively, and completely removed from most surfaces without damaging them, without making any visible alteration thereto, without permanently altering the integrity of, and without devaluing the surface of the substance/material to which it had been applied. Also, pieces of present invention sheet film are adapted for the erasable receipt of markings that include written notes, designs, symbols, artwork, stickers, decals, and/or other personalized informational markings which cause a person's attention to be drawn to a passage in a book or a portion of any larger surface or object such as but not limited to an industrial sign used for enhancing workplace safety. Thus, the present invention sheets can be used as a study aid, wherein a student can accentuate entire pages or group portions of them that have not yet been committed to memory (the previously explained pocketed configuration is easy and convenient for such accentuation or highlighting), used for easy location of the information or item within a book or other grouping of pages that one expects will need frequent/repeated review, used to add notes to the exposed surface of the sheets where needed for inclusion of additional information, and then used to erase the notes and/or remove the sheets when the information highlighted is learned and no longer needs an easy distinguishing reference. The present invention sheet film can be repeatedly applied and removed from the same position on a book, page or other item or surface without damaging or visibly altering the book or surface, or the sheet film. When one reads the following invention description, one will understand that the present invention sheet film can be employed in many more applications, and only a few have been provided here by way of example.

As a part of the distribution of present invention sheet film as a kit in a package, the present invention may include a marking means compatible with the sheet film that allows legible erasable markings to be made thereon, subsequently removed as needed, and then reapplied numerous times as the sheet film is reused. Although not limited thereto, markings may be in the form of applied markings, or markings that become visible as pressure is applied (hereinafter referred to by the words etched markings) and similar in appearance to children's toys which allow a stylus marking on a screen to make lines and images without the application of ink. Pressure may cause any type of visual change, such as but not limited to darkening, lightening, and/or the appearance of a distinguishing color. Further, applied markings may be saved to the substrate, or removed and stored for future referencing and/or passed on to others who share the same documentation or subject matter. Once removed from a substrate, the highlighting provided by the present invention sheet film becomes cryptic and private. When reapplication of present invention highlighting sheet film occurs over the original subject matter targeted for highlighting, or over duplicate subject matter, the meaning/intent of the highlighted markings is again revealed. In the alternative, instead of immediate reapplication without alteration, any piece of present invention sheet film may be cleaned, subdivided, and/or otherwise prepared for reuse in the same or a similar application, and/or reconfigured for a different application, or it may be discarded and never reused.

The mounting means used to attach pieces of present invention sheet film to the surfaces targeted for highlighting can include very low tack adhesive, electrostatic means, folded and wrapped and pocketed sheet film models, or a combination thereof. Additional features of the present invention sheet film that assist in preserving a selected application of highlighting sheet film to a substrate for continued use in a designated location, include but are not limited to, punched holes, a tucked configuration involving the binding edge of the page it surrounds, and creasing. Placing the present invention sheet film into a selected location of use may involve mounting means employed on one or both of its sides, with mounting means on two sides that allow the sheet film to be inserted between two surfaces, or positioned around one or more surfaces so as to adhere such surfaces together while accentuating a portion or all of them. Use of present invention colored sheet film to secure at least two sheets together can also accentuate a portion or all of them by varying the color of the light passing collectively through all or a part of them. It is contemplated that any adhesive or other mounting means used for placing the present invention sheet film into a selected location allow the substrate below it to be viewed without obstruction, where blocking out areas is not the intent. Further, while the present invention can be pre-manufactured to innately carry an electrostatic charge, dispensing or other apparatus may also be used to apply the charge to the film prior to actual application.

Other options in a present invention highlighting sheet film system, method and apparatus include but are not limited to, inclusion in a kit or package intended for distribution to end consumers of one or more colored and/or colorless marking instruments (which hereinafter may be referred to as a kit pen), one or more pieces of cloth adapted for cleaning and/or surface preparation of present invention sheet film to include erasure of markings applied to the exposed surface of sheets and/or creating an electrostatic charge, one or more cutting instruments, one or more templates with suggested cutting patterns for maximizing use of the present invention sheet film and/or adapted for storage of new and used sheet film, one or more cutting tools, adhesive/mounting means adapted for user application and temporary or permanent sheet film affixation without permanent substrate alteration, and combinations thereof that allow marked or unmarked present invention sheet film to be saved and/or stored and reapplied for future use/referencing, and/or passed along to others who may share the same printed material or subject matter, and also allow markings to be removed from sheet film to return it to its original condition. Although it is contemplated for present invention sheet film to be reused one or more times in the same and/or different highlighting application, it also may be discarded at any time. Other optional features of the present invention sheet film include manufacture from pH balanced/neutral materials for archival and other applications, a top and/or bottom surface capable of receiving applied highlighted markings and other personalized informational markings optionally provided by use of a colored and/or colorless kit pen, pre-sectioned sheet film with or without a releasable backing/liner that protects or preserves the very low tack adhesive and/or electrostatic charge prior to use or repeat use (the backing/liner of which can also be reused for accentuation and/or blocking), sheet film pre-formed as a pocket, sheet film with light reflecting capability, sheet film with light absorbing capability, sheet film with light refracting capability, sheet film with polarizing capability, sheet film with magnifying capability, sheet film with visualization enhancements, disposable sheet film configured for one-time use, and reusable sheet film configured for use multiple times, providing sheet film cut into one or more pre-sized pieces, providing sheet film in a continuous length on a roll that can be cut or otherwise subdivided for customized highlighting use of large items or objects, providing pre-cut and/or pre-scored and/or strip release lined pieces of sheet film, providing sheet film with perforated markings that assist in user creation of customized sizes, and providing sheet film with pre-cut, perforated, and/or pre-scored markings that assist in user creation of customized sizes appropriate to an intended application via user separation/cutting a desired length from any of the provided pre-cut, pre-scored, and perforated film pieces, and/or by user folding and/or sealing to create a closed end in any piece of sheet film to form a pocket. Further, erasure of the notation in a second layer/level/echelon of highlighting on present invention sheet film, cleaning its exposed surface, or otherwise preparing present invention sheet film for reuse, is not limited by use of cloth alone, and can be by separating two pieces of highlighting sheet film to remove ‘etched’ markings, or by any other appropriate method or means compatible with present invention highlighting sheet film. For example, liquid cleaner or liquid cleaning agents, to include water, may be used with or without a cloth that is pre-treated, untreated, pre-moistened and/or used dry. Further, the cleaner or cleaning agents may be a liquid provided as a part of a present invention kit or package, or individually sold, and may be housed in a container, such as but not limited to a spray bottle, and/or contained within a kit pen. In addition, sheet film, adhesive, cloth, kit pen, and optionally cleaner, and/or template, cutting instrument, and the other component forms that make up present invention kits or packages, all may be enclosed together in or as a part of the same kit or package, or may be sold individually, or in differing combinations as replacement packages, and/or sold in bulk as refills.

2. Description of the Related Art

Highlighting markers employing inks and dyes are widely used to permanently highlight hand-written and typewritten markings, such as but not limited to the text in a book. Highlighting centers the viewer's attention and/or emphasizes a particular/specific area of interest or significance, for easy visual reference by the person applying it for repeated personal viewing, and/or viewing by others. Hand-held apparatus for this type of highlighting is particularly convenient, which are configured for making broad strokes capable of covering one line of text at a time, and/or fine strokes more suited to underlining printed text. Conventional markers are not suitable for writing notes on film. The disadvantage of such highlighting is that it permanently marks the substrate upon which it is applied, with the released ink or dye permanently altering the quality, condition, and/or value of the book or other material to which it has been applied, which are then irreversibly changed and cannot be restored, resulting in its devaluation and/or complete loss of substrate function for other potential uses. Further, personal highlighted materials/notes made by prior art means have no privacy, and can be viewed by anyone looking at the book or substrate material. Other disadvantages are that the highlighting inks and dyes used can bleed or soak through some substrates, such as paper and cloth, and bead-up on other incompatible surfaces, such as plastic, vinyl, and metal. Further, highlighting pens and markers are impractical for marking large areas. To do so is time consuming and require large amount of colorant to be used and therefore wasteful and not economical. the overlapping lines leave an uneven deposit, which can obscure underlying text or images. In addition, the inks and dyes of markers and marking pens release inks and dyes directly into the substrate and work by saturation and permanent staining of the substrate the such as paper-stock, leaving it in a weakened condition and at risk for tearing and/or other forms of deterioration. In addition, multiple layers of ink and/or dye can smear and distort underlying print, causing it to become discolored and less legible. Markers with means of erasure applied are applied directly to the already saturated substrate causing further damage and print distortion as a result, and also do not effectively preserve the condition of the substrate. as a result nor is the substrate pre-vented from irreversible damage. Further, the ink and dyes in marking pens and markers can prematurely dry out, rendering them useless and therefore the method of highlighting is immediately lost. A further means of prior art highlighting and/or accentuation is found in the form of clear, colored, or partially colored tabs sometimes in the configuration of an arrow with or without printing (such as “Sign Here”), which has adhesive on a portion of its back surface that allows for the common practice of temporary attachment to a piece of paper (and other surfaces) and later removal without damaging the paper's top surface, with the other portion of the tab's back surface being non-adhesive and usable for leverage in easily removing the tab from its temporary location. The present invention, however, can do it all. It provides features and benefits not available nor achievable with conventional methods of highlighting. It provides a variety of models configured by pre-sectioning, and/or folding and/or sealing highlighting sheet film to provide the user for a variety applications determined by the user. It is readily usable on paper, as well as a variety of other surfaces and provides a system and method and apparatus that is compatible with plastic, and vinyl, without permanent damage or distortion to the object highlighted. Present invention with erasable feature allow similar method of quickly marking single words and large sections or areas quickly and easily and optionally provides a system and method whereby the convenience of a handheld instrument is an option, and/or the provides the option of pre-colored versions that may be used without the use of a marking instrument. It can be used for accenting or highlighting single words, lines, paragraphs, and/or pictorials on a page of text, and/or adhere and highlight one or more transparent and/or translucent surfaces together to accentuate a portion or all of them. Also, this invention highlighting sheet film is colorless with color as an option, wherein colorants are provided in or on film. Custom features allow colorless or colored sheet film versions, and/or folded and/or pocketed versions providing highlighting coverage instantly, and models that can be used to highlight/identify entire pages II and/or sections in a book as well as use in highlighting other large areas quickly, easily and efficiently. Thus, the present invention can be used to highlight on single and multiple pages, and/or in sections, to partially or fully highlight any or all of it at once for instant identification by a viewer or reader, and may optionally be viewed by others.

The present invention can comprise a variety of colorless and pre-colored film configurations, as well as marking means that directly apply markings or make them via pressure sensitive means. Further, preferred distribution of present invention sheet film is as a kit in a package, and the present invention may include a marking means compatible with the sheet film that allows legible erasable markings to be made thereon, subsequently removed as needed, and then reapplied numerous times as the sheet film is reused. Although not limited thereto, markings may be in the form of applied markings, or markings that become visible as pressure is applied (hereinafter referred to by the words etched markings) and similar in appearance to children's toys which allow a stylus marking on a screen to make lines and images without the application of ink. Pressure may cause any type of visual change, such as but not limited to darkening, lightening, and/or the appearance of a distinguishing color. Further, applied markings may be saved to the substrate, or removed and stored for future referencing and/or passed on to others who share the same documentation or subject matter. Once removed from a substrate, the highlighting provided by the present invention sheet film becomes cryptic and private. When reapplication of present invention highlighting sheet film occurs over the original subject matter targeted for highlighting, or over duplicate subject matter, the meaning/intent of the highlighted markings is again revealed. In the alternative, instead of immediate reapplication without alteration, any piece of present invention sheet film may be cleaned, subdivided, and/or otherwise prepared for reuse in the same or a similar application, and/or reconfigured for a different application, or it may be discarded and never reused. In addition, the present invention is fully removable from the substrate to which it is attached during use for preserving the handwritten, highlighting and highlighted markings made to film with it for future referencing whose marked lines may be erased by the end consumer. Removal keeps personal highlighting notations private and reapplication allows the personal highlighted notes to be re-viewed at a later time by the original user, or optionally viewed by others who receive the personal highlighted notes (or a copy thereof) and share the same documentation or subject matter. Equally important is that the present invention protects substrate to which it applied, as long as it remains in place. Thus, present invention film may be removed and thereafter saved for future referencing of the same text or substrate, cleaned and reused on the same or a different substrate multiple times, subdivides for differing use on the same or a different substrate, and/or disposed or discarded. Although pre-colored film models of the present invention can optionally include hand-held instrumentation in the form of a kit pen, the combination of present invention film and kit pen can do so much more than the prior art highlighting pens and markers alone could do. It is contemplated for the present invention kit pen to be used for adding permanent and/or temporary markings that may be removable from the film and reused. In addition, present invention sheet film may be used prior to bookbinding, can be layered, optionally photocopied to include colorants that disappear, used for accenting, highlighting, and/or for blocking out with erasable highlighting film kit/one highlighting product embodiment.

It is important to distinguish the highlighting sheets of the present invention from the highlighting tape disclosed in U.S. Pat. No. 5,707,482 to Fusselman (1998). It is contemplated for the Fusselman tape to be reusable, dispensed from a roll, and cut or torn. In addition, the Fusselman adhesive is non-permanent and can be easily removed from a surface without harming it, and leaves leaving no adhesive residue behind after removal. The Fusselman disclosure teaches a highlighting tape having a width that allows coverage for a single line of text, or 2-3 lines of text, as well as a highlighting tape that is thin, colorfast, translucent, clear, or opaque and run through a standard coater for a very thin uniform layer of translucent, pressure sensitive adhesive. Claims in the Fusselman disclosure are directed only to a highlighting tape in combination with a hand-held dispenser. In contrast, the present invention highlighting sheet film is configured for highlighting more than a line or two of text, and more than pages in a book, including such industrial uses as highlighting all or portions of industrial signs, floors, walls, and other large surfaces. In addition, it is contemplated for the present invention to be used on, but not limited to, one or more paragraphs on a page, all or part of an image on a page, the accentuation of such substrates as artwork, painted surfaces, glass, plastic, and vinyl, in addition to highlighting of paper. Within the visible perimeter of the present invention sheet film, a first layer/level/echelon of highlighting is defined. However, the present invention sheet film is important and distinguishable for being capable of accepting a second layer/level/echelon of colored and/or colorless, transparent and/or translucent highlighting film substances, including but not limited to colorants, adhesives, that contrast film from the substrate it covers/highlights, film and the substrate it covers/highlights, and film from film and the substrate it covers/highlights, and may also include applied colored markings, markings that become visible as pressure is applied, and/or colorless markings. Further, the present invention sheet film may also be colorless, pre-colored, or colored by the user, making colorants an optional, but not critical, element for present invention function. The Fusselman tape is colorfast and requires a thin layer of adhesive. Thus, the lack of color or colorless film with the option of pre-coloring and/or with optional color applied by the user is another feature of the present invention that distinguishes it from the Fusselman invention. Also, not all of the present invention sheet film models require adhesive. Forms of sheet film/substrate association can be low tack and no-tack that includes but is not limited to folding and wrapping, and/or tucking, and/or sealing to provide closed ends. In addition, the Fusselman disclosure does not teach the ability to accept a second layer/level/echelon of highlighting that critical to the present invention, with the further capability of being erasable so that replacement second layer/level/echelon of highlighting can be later added one or more times according to need to the same or a different substrate.

Further, even though it discloses a support film that can have a colored layer and is adapted for editing purposes to add notes to page of text, or send a message to someone, and even though it does not teach a highlighting film for accentuating subject matter already present on a substrate or portions thereof or making any substrate area optically noticeable at a glance, as in the present invention, it is important to distinguish the invention disclosed in U.S. Pat. No. 4,985,302 to Sala (1991) from the present invention. The Sala invention comprises a support sheet with an adhesive layer that is adapted for removable attachment of the support sheet to written surfaces so as to allow the addition of editing annotations, additions, corrections, and the like (Column 1, lines 16-17) to a written surface in need of alteration. When used for such editing purposes, the Sala support sheet is transparent (Column 1, line 17), however, when used for writing messages, the Sala support sheet is opaque and has the adhesive applied only along one edge (Column 3, lines 19-20). In contrast, the present invention is a means for highlighting, accentuating, and/or otherwise drawing attention to text, images, surface markings, and other subject matter already present on substrate so as to make it optically noticeable at a glance. However, use of the present invention allows both addition and subtraction highlighting techniques to be used, with addition being defined herein as enhancement/accentuation of a specific area and subtraction being defined herein as blocking out a portion of a substrate to enhance the noticeability of the adjacent and/or remaining substrate surface. The focus and function of the present invention is highlighting, and not the adding of editing corrections, notes, or messages to a written surface in need of alteration. Within the visible perimeter of the present invention sheet film, a first layer/level/echelon of highlighting is defined, which is considered the most generic protectable subject matter of the present invention defined in the accompanying claims, such as but not limited to one or more paragraphs on a page, all or part of an image on a page, or a portion of a sign on a wall, as well as the accentuation of such substrates as artwork, walls, floors, painted surfaces, glass, plastic, vinyl, and paper. This first layer/level/echelon of highlighting is protected subject matter in the most generic one of the claims accompanying this disclosure. However, the present invention sheet film is also adapted to accept a second layer/level/echelon of highlighting via the use of one or more peripheral components, which can be sold in a package with one or more pieces of present invention sheet film or sold independently from the present invention sheet film. The tools may be selected from components/peripherals that contrast film from the substrate it covers/highlights, film and the substrate it covers/highlights, and film from film and the substrate it covers/highlights, as well as apply colored markings, markings that become visible as pressure is applied, and/or colorless markings. The Sala self-adhesive sheet may or may not have vivacious coloring (Column 1, line 31) that immediately attracts the eye to the annotations, additions, corrections to be made in the margins or between two lines of text on a page (Column 1, lines 20-21). However, such reader attraction is limited to the editing notations, and is not focused on or made to highlight specific subject matter on the substrate. Since the present invention sheet film may also be colorless, pre-colored, or colored by the user, making colorants an optional but not necessary element for present invention function, the presence of color or lack of color is not a feature that distinguishes the Sala and present inventions from one another. In addition, the Sala disclosure teaches one side of its support film/sheet having an ink layer of pigment and ethanol that is capable of being written on to provide annotations, additions, corrections, and the like (Column 2, lines 47-60). In the alternative, the Sala film can be colored throughout and have one face treated to allow it to be written upon by pencil and pen, (Column 3, lines 4-6), or one of its surfaces treated to make it suitable for writing and the colored ink on the other surface of the support film as a layer between the support film and the adhesive. In contrast, not all of the present invention sheet film models require adhesive. Also, the present invention comprises etched markings created as a result of pressure application and erasable markings created via a compatible kit pen, and not markings from a commonly available pencil or pen. Further, forms of sheet film/substrate association in the present invention can be low tack and no-tack that includes but is not limited to folding and wrapping, and/or tucking, and/or sealing to provide closed ends. Further, the Sala disclosure teaches a means of writing on a piece of transparent polymer film that can be removably attached to text or a drawing on a page between lines of text and in a margin, or the use of an opaque piece of polymer film that can be removably attached to a page for writing a message, and does not teach removable highlighting sheet film that highlights subject matter on a substrate and is capable of receiving a second layer/level/echelon of highlighting, which is also erasable or otherwise removable from the sheet film so that replacement second layer/level/echelon of highlighting can be later added one or more times according to need.

The erasable highlighting film kit of the present invention allows a user to share highlighted-material, while maintaining an advantage in keeping the content of the highlighted material private as soon as the film is removed from substrate. Teaches may use this privacy advantage in preparing test questions. Reapplication of the present invention film allows personal notes to be re-viewed when desired, or kept private. An optional built in self-adhering sheet tab feature of the present invention can be used to identify a highlighted location by marking it using colorless or colored sheet film to identify pages and/or sections. Further, highlighted information may be grouped by color and in sections. The present invention sheet film acts as a protective layer for its substrate, protecting book pages from food and beverage stains, as well as protecting the visible surface of industrial signs from airborne particulate, oil droplets, moisture, and other potentially deteriorating substances. Also, when used for accentuation purposes, as opposed to blocking undesirable portion of a substrate, the present invention provides highlighting sheet film with visual clarity that allows the addition of highlighting, text, designs, images, and other artwork to substrate surfaces while preserving them.

The present invention uses electrostatic charge, no tack, and/or very low-tack repositionable adhesive in association with its sheet film to achieve the highlighting function without any visible alteration or devaluation of the vast majority of substrates to which it is applied. Also, it may be formed into a pocket that is secured by press-fitting it into a book binding, from which it can be readily withdrawn after use. Sheet film may be adapted for sealing as to provide one or two closed ends or edges when a pocket is made. Further, the present invention is readily usable on paper, as well as a variety of other surfaces, to include but not be limited to books, industrial signs, and art, and it does not have any of the prior art disadvantages noted above. While conventional methods of highlighting text focus on the use of highlighting markers, the present invention comprises a method for highlighting that employs colorable and erasable highlighting sheet film that is readily and safely used on paper substrates without visible damage to the paper surface models to which it is attached after sheet film removal, that causes no permanent color distortion to highlighted object, with some models of the present invention having no risk of substrate damage, and which optionally include plastic and vinyl films that do not bead or smear and will not cause irreversible substrate damage, and it does not have any of the prior art disadvantages noted above. No existing product is known to have the same features or highlighting capabilities as the present invention.

### BRIEF SUMMARY OF THE INVENTION

The primary objective of the present invention is to provide end users with sheet film having highlighting capabilities and/or erasable highlighting features.

It is also an objective of this invention to provide visually and/or optically clear, transparent and translucent, and other highlighting film substances, and also to provide qualities including but not limited to visually and optically clear transparent and translucent, colored, clear-colored, and clear-colorless, or in the alternative when it is determined that blocking out unwanted portions of a substrate targeted for highlighting is more efficient and/or less time consuming for a user, it is a further objective to provide highlighting film substances made from light-absorbing and/or darker colored materials and applying them to areas around the portions of a substrate needing accent or emphasis so as to subdue the surrounding areas and thereby cause the targeted portions to be optically enhanced or significantly more noticeable.

Another object of this invention is to provide adhesion methods for repositionable anchoring of highlighting sheet film to a substrate involving one side of the sheet film, two sides of the sheet film, light adhesive, very low tack adhesive, electrostatic charge, a liner and/or lining that may be kiss-cut, by die or any other method of slitting including cut corners for easy peel, attachment and release, fully coated or partially or zone coated sheet film by direct or indirect methods, pressure sensitive methods, non-pressure sensitive methods, adhesive-free methods and other no tack methods such as but not limited to folding and/or wrapping and/or tucking engagement.

It is also an object of this invention to provide highlighting sheet film whose component forms provide flat or folded, colored and colorless, pre-scored, pre-cut, perforated, break-away, strip-lined, adhesive and/or no tack versions, whose method and apparatus are used for temporary and/or permanent/indefinite affixation of highlighting sheet film to a substrate once it is applied, is fully removable for the purpose of preservation of highlighted markings made to film and preservation of the substrate to which it is applied.

It is a further object of this invention to provide a highlighting system wherein colorless sheet film is used that can be pre-colored by the manufacturer and/or colored by the end user.

Another object of this invention is to provide methods of using highlighting sheet film in association with one side and/or two sides of a single bound or unbound page, and/or adjacent and/or parallel surfaces.

It is also an object of this invention to provide method and apparatus for temporary and/or permanent and/or long term affixation of highlighting sheet film to a substrate that may be easily removable at any time, and multiple times, without visible damage to the sheet film or the substrate, including but not limited to marring, wrinkling, discoloring, distorting, and/or leaving an impression in/on the substrate.

It is a further object of this invention to provide a highlighting sheet film system with multiple forms of film adhesion used alone or in combination with one another.

Another object of this invention is to provide adhesion methods for repositionable anchoring of highlighting sheet film to a substrate involving one side of the sheet film, two sides of the sheet film, light adhesive, very low tack adhesive, electrostatic charge, a liner and/or lining, die cut corners, that may be kiss-cut, by die or any other method of slitting including cut corners for easy peel, attachment and release, fully coated or partially or zone coated sheet film by direct or indirect methods, pressure sensitive methods, non-pressure sensitive methods, adhesive-free methods and other no tack methods such as but not limited to folding and/or wrapping and/or tucking engagement.

It is also an object of this invention to provide method and apparatus for affixation of highlighting sheet film to a substrate that is applied by the sheet film manufacturer and/or by the end user, applied by the end user to already treated film for additional adhesion, or to add adhesion such as but not limited to the conversion of no tack sheet film to sheet film with adhesive, and/or with the option of the same adhesive means applied by the manufacturer also being provided to the user for application or reapplication by the user.

It is a further object of this invention to provide highlighting sheet film with erasable highlighting feature, and further with mounting/affixation/anchoring means that does not obstruct viewing of the substrate to which it is attached.

It is also an object of this invention to provide a marking tool hereinafter generally referred to as a ‘kit pen’ configured for creating markings on present invention highlighting sheet film that can remain on the sheet film for a short period of time or indefinitely, which optionally can be erased, for the purpose of accentuating or highlighting colorless film versions and further contrasting colored film.

It is another object of this invention to provide a marking tool, and optional method of marking or accentuating highlighting sheet film, that provides a second layer/level/echelon of highlighting substances, the method including both the addition and removal of the second layer/level/echelon of highlighted markings.

It is a further object of this invention to optionally provide the convenience of a hand held instrument in the form of a kit pen compatible with the receptivity of the sheet film by which the user can make temporary and permanent applied markings to sheet film models.

It is a also an object of this invention to provide a marking means for highlighting sheet film wherein applied markings may be removed by erasure and/or cleaning, thereby providing the user with the option of reusing the sheet film in another highlighting application.

It is a further object of this invention to provide methods of marking sheet film that are compatible with the structure of the highlighting sheet film or films intended for use, and also include but are not limited to colored and colorless, and/or temporary and/or permanent markings.

It is another object of this invention to optionally provide a single or multiple tipped marking tool or kit pen adapted for narrow and/or broad markings for creating fine lines used for writing and/or underlining; and/or broad-tip for creating wider or broad-lines adapted for more efficiently accentuating and/or highlighting large areas/sections.

It is another object of this invention to optionally provide a highlighting system comprising one or more pieces of sheet film, film adhesive, at least one colorant, cloth adapted for cleaning/preparing sheet film for use and/or generating electrostatic charge, at least one kit pen, and/or liquid cleaner enclosed together in a package.

It is also an object of this invention for the removable film adhesive means, colorants, cloth, kit pens, and/or liquid cleaner capable of being enclosed together in a package to also be sold separately from the highlighting sheet film, sold individually, sold in varying combination as replacement packs, and/or sold in bulk as refills for user convenience, and/or optionally include one or more of the same or different individual components,

It is a further objective of this invention to provide various systems and methods for removably highlighting and/or accentuating preferred sections of text, other printed material, and other objects to make them immediately visually/optically noticeable at a glance for easy visual reference, such as but not limited to books, paper, single and multiple bound and unbound sheets, entire sentences or parts thereof, paragraphs, pictorials, and also to provide accent to other objects such as but not limited to floors, walls, and painted surfaces, glass, cloth, vinyl, plastic, metal, stone, wood porcelain and composites thereof.

It is also an object of this invention to provide a system of highlighting whose method and apparatus allows personal highlighted subject matter to be preserved for future referencing, removed from the substrate to which it was attached to maintain privacy of personal highlighted subject matter, saved, stored, reapplied in the same application or a different application, cleaned and prepared for reuse in the same or a different application, reconfigured for reuse in the same or different applications, and/or optionally discarded without visible text or identification of the substrate from which it was originally taken or highlighted, and also whereby reapplication allows personal notes to be re-viewed when desired, and/or passed along to others who have the same material or subject matter for shared viewing.

It is another object of this invention to provide a highlighting sheet film system that easily provides a variety of standard application methods as well as custom sizing applications for easy customer use.

The present invention provides highlighting sheet film with erasable feature whose component forms of sheet film, comprise visually and/optically clear transparent and translucent and other highlighting film substances, and also provides the user sheet film qualities that include visually and optically transparent and translucent, colored, clear-colored, and clear-colorless; forms of film adhesion, with and without colorant means used to form various systems and methods for highlighting and accentuating preferred sections of text, other printed material and other objects to make them immediately visually noticeable for easy visual reference, and the use of which does not damage the substrate to which it is applied. During it use, the present invention highlighting sheet film adapted for receipt of user applied markings can be flat, or folded, colored and colorless, pre-scored, pre-cut, perforated, or strip-lined, include adhesive and no tack versions whose method and apparatus is used for temporary and/or permanent affixation of highlighting substance to a substrate once applied, may be removed for the preservation of highlighted text and other substrates desired to be accentuated or highlighted that may be shared with others, saved, stored, and/or reapplied without damage to the substrate. The present invention sheet film also can be used in the following forms: folded, flat folded and sealed as to provide closed ends, and, in addition, they may also be used in their entirety or further sized into smaller pieces for alternative application via scoring, cutting, perforating, folding and/or wrapping, and/or tucking so that the highlighting sheet film/product herein can cover two opposing sides of a single bound or unbound page, and/or adjacent and/or parallel surfaces. Thus, the present invention provides a film, film options, film models and film application methods that provide the user with a system and methods for highlighting substrates in a variety of applications, and further provide a highlighting sheet film that is fully removed and may be reapplied one or more times to the same or different substrates, all without visible damage to the film or the substrate or substrates to which it had been affixed. It is important for the present invention highlighting sheet film to be foldable, so as to provide to the user a variety of sheet film options such as flat sheeted film in a variety of sizes and configurations; to provide the user with options of flat, pre-sized and/or continuous flat-sheeted, pre-folding flat-folded, and pre-pocketed sheet film models according to customer need for user convenience; and to provide the user pre-sectioned sheet film by slitting, pre-scored, precut, perforated, folded, folded and pocketed, pre-folded and/or sealed to provide closed ends, double-sided adhesion, strip-lined adhesive, and no tack versions; wherein sheet film and sheet film models may be used in their entirety, subdivided into smaller strips or pieces for alternative applications, or added to other sheet film pieces for larger size areas or applications. An additional contemplated feature of the present invention is to provide manufacturer applied methods relating to the highlighting sheet film that can also be applied or adapted by the user, to include but not be limited to scoring, cutting, perforating, folding and/or wrapping, tucking, adhesive sealing, whereby custom sizing can be achieved. In essence, the present invention provides a highlighting sheet film whose component forms consist of erasable highlighting sheet film substances, forms of film adhesion; coloring system and/or colorants used for providing pre-colored film that optionally may also be provided in the form of kit pens and may provided in a package with highlighting sheet film to end users. Kit options also include a cloth, film adhesive, and/or cleaner. The cloth may be adapted for cleaning/preparing the surface of the present invention sheet film and/or generating electrostatic charge. The kit pen, cloth, adhesive, colorants, and cleaners can each be sold separately from the highlighting sheet film, in bulk, or in replacement packaging in varying combination, and/or sold as refills. Use of the kit pen creates colored and/or etched markings on the present invention film that is important for colorless present invention highlighting sheet film, and remains optional for colored present invention sheet film. The highlighting sheet film of the present invention can remain affixed to the surface of a substrate indefinitely without damaging or otherwise visually altering it, including leaving a colored impression or indentation. However, one important application of the present invention is to provide a highlighting sheet film with erasable feature that once marked may be erased or left on the film for future referencing, and/or passed on to others who share the same documentation or subject matter and/or thereby reapplication markings may be reviewed; and to provide an erasable highlighting sheet film that may be erased by cleaning/preparing it for reuse or may be reconfigured for the same application and/or reconfigured for a different application, or may be disposed/discarded, and to provide by this method of accent or highlighting to film once removed from the surface of the substrate provides method whereby highlighted markings remain visually obscure and privacy is retained. Although not limited thereto, the present invention may comprise a translucent sheet film that when placed against the substrate becomes visually clear. In addition, the highlighting sheet film of the present invention should be easy to clean, and its capability of being reused makes it economical, saving/preserving paper and books, generating less waste, and promoting recyclable uses. A variety of dispensing sizes and configurations of present invention sheet film are contemplated for user convenience, which could include but are not limited to sheets of various sizes with or without protective backing, a loose collection of individual strips or sheets, flat folded and pocketed models having similar of different sizes that are packaged together for sale. Dispensing could also require and include the highlighting sheet film being attached to, removed from, and/or re-attached to a release liner or sheet on one or both of its sides. Further when present invention highlighting sheet film is provided with adhesive surfaces that face one another and dispensing occurs from a roll, two individual sheets can be dispensed at one time. Thus, highlighting film sheet may optionally have a top surface and/or bottom surface that will accept permanent and/or temporary highlighting markings by use of a marking tool or kit pen that may optionally be used to optically accentuate clear, colored, clear-colored, clear-colorless erasable highlighting film and since such markings are compatible with the receptivity of the film, users can make temporary and permanent applied markings contrasting film highlighting with other highlighting and/or text. In addition, it is desired for the present invention highlighting sheet film to be environmentally compatible, by providing a highlighting product that is non-toxic and does not adversely affect the environment during or after its use, is reusable and therefore is recyclable by virtue of its reusability, is economical, saves paper and therefore generates less waste than the use of traditional highlighting markers.

The description herein provides preferred embodiments of the present invention but should not be construed as limiting its scope. For example, variations in the length, width, and thickness dimensions of the highlighting sheet film used, or subdivided portion thereof; the number of perforations and pre-scored markings on each highlighting sheet film used, whether the sheet film is pre-sectioned or formed into a pocket with at least one sealed edge; whether a release liner or other sheet is used with the highlighting sheet film; the means used to apply an electrostatic charge to the sheet film; and the types of adhesion means used, other than those shown and described herein, may be incorporated into the present invention. Thus, the scope of the present invention should be determined by the appended claims and their legal equivalents, rather than being limited to the examples given.

### BRIEF DESCRIPTION OF THE DRAWINGS

FIG. 1 is a top view of a preferred embodiment of the present invention showing a single piece of approximately 8⅜″×10¾″ dimensionally stable transparent pre-colored erasable highlighting sheet film that displays marked lines are drawn across the surface of sheet film to cover text, made by use of a colored and/or colorless marking instrument identified herein as a kit pen, which highlight sentences, and/or outline a pictorial found on a page in a book or one another substrate, so that when the film overlays the text and pictorials to which the marked lines originally apply, they accentuate selected areas of the underlying page or substrate to make them optically noticeable to the viewer, and when the film is removed from the substrate the markings have no meaning to a viewer and the privacy of what they represent is preserved

FIG. 2a represents a perspective view of a preferred embodiment of the present invention as a transparent clear colorless or otherwise optically noticeable self-adhering erasable highlighting sheet film folded in half across its width dimension.

FIG. 2b represents the same perspective view of the preferred embodiment of the present invention shown in FIG. 2a, with a page targeted for highlighting inserted between the folded halves of the transparent clear-colorless or otherwise optically noticeable self-adhering erasable highlighting sheet film.

FIG. 3a is a top view of a preferred embodiment of a piece of visually transparent clear-colorless present invention sheet film that is pre-scored and perforated, approximately 10¾″×26¼″ in dimension, and optionally separable into smaller pieces by its user, and via adhering means pre-applied during manufacture or adhering means applied to the film by the user prior to its association with a substrate for highlighting purposes, can be applied by the user to a substrate in its entirety or in smaller flat and flat folded configurations, such as illustrated in FIGS. 3b-3e.

FIG. 3b is a top view of a preferred embodiment of a piece of visually transparent clear-colorless present invention sheet film that is separated from a dimensionally larger pre-scored and perforated sheet for custom sizing, which can then be applied by the user in its entirety or in smaller flat and flat folded configurations, such as illustrated in FIGS. 3c-3e.

FIG. 3c is a top view of a preferred embodiment of a piece of visually transparent clear-colorless present invention sheet film that is separated from a dimensionally larger pre-scored and perforated sheet for custom sizing, which can then be applied by the user in its entirety, in smaller flat configurations, or the folded configuration illustrated in FIG. 3e.

FIG. 3d is a perspective view of a preferred embodiment of a piece of visually transparent clear-colorless present invention sheet film that is separated from the dimensionally larger pre-scored and perforated sheet shown in FIG. 3a for custom sizing, and which is folded prior to being applied by a user to a substrate instead of being used flat as shown in FIG. 3b.

FIG. 3e is a perspective view of a preferred embodiment of a piece of visually transparent clear-colorless present invention sheet film that is separated from the dimensionally larger pre-scored and perforated sheet shown in FIG. 3b for custom sizing, and which is folded prior to being applied by a user to a substrate instead of being used flat as shown in FIG. 3c.

FIG. 4 is an illustration of a single sheet of present invention visually clear translucent sheet film attached to a release liner pre-scored across its width and length, and/or diagonally to form geometric shapes, strips, and blocks dispensed from or placed on a release liner between uses.

FIG. 5a is a top view of a pre-pocketed preferred embodiment of the present invention self-adhering clear-colorless highlighting sheet film sealed on two sides.

FIG. 5b is a top view of a present invention self-adhering colored highlighting sheet film folded in half forming a strip tab along the outside perimeter of an unbound page with the adhesion side facing interiorly toward the top and bottom surface of an unbound page.

### DETAILED DESCRIPTION OF PREFERRED EMBODIMENTS

The present invention provides a system/method and apparatus used for temporary and permanent accent or highlighting to the surface of highlighting sheet film with erasable feature; highlighting sheet film that can be pre-colored by a manufacturer or the end user; highlighting sheet film with a top surface and/or a bottom surface capable of accepting temporary and/or permanent accent or highlighting compatible with the surface receptivity of the film markings from marking tool or kit pen; colorant and/or adhesive means, a highlighting sheet film model that optionally has a top surface and/or bottom surface provided with very low tack adhesive and/or no-tack versions; and a highlighting sheet film that may be printed upon, attached to a liner, provided as a liner (that may be stacked with one or two tacky sides attached to sheets or strips) capable of contrasting film from the substrate it cover/highlights, film and the substrate it covers/highlights, and/or the film from film and the substrate and/or the object it covers, once highlighting film is in its usable position or is applied to the substrate it covers. In addition, the present invention provides the user a highlighting sheet film that may be pre-sized for used in their entirety or further sized into smaller pieces for alternative application by slitting, scoring, perforating, and/or folding and/or closing or sealing to provide closed ends, highlighting sheet film compatible with a marking tool/instrument used for accentuating or highlighting colorless film and optionally further accentuating pre-colored film. Thus, users are provided with a variety of film options that may be applied during manufacturing and/or prior to application for a custom fit. Other present invention highlighting sheet film options include but are not limited to the following: pre-sized and/or continuous, as well as pre-formed and/or pre-sectioned film models that may be used in their entirety, further sized into larger and/or smaller pieces and/or re-configured from the original form to fit alternative applications. Custom sizing can be via separation, cutting a desired length of pre-sized pre-cut, pre-scored, and perforated and/or continuous film pieces, and by folding. Further, pre-pocketed film models may be folded and/or sealed to provide closed ends on one or two sides. The system, methods and apparatus of the present invention also provide the user with ways in which to adapt the highlighting sheet film according to need and application, via such means as flat folding and pre-pocketed film models, folding and wrapping, unfolding and/or creasing, and reverse creasing. To provide a variety of highlighting sheet film options in the present invention, include but are not limited to, visually and/or optically clear transparent and translucent, and other erasable highlighting sheet film substances; highlighting sheet film that is visually and/or optically clear transparent and translucent clear, colored, clear-colored, clear-colorless; and, pre-formed film models and methods of applications that allow the user to pre-form present invention highlighting sheet film prior to application by providing flat sheet, strip, folded and/or, and foldable erasable highlighting sheet film. The present invention highlighting sheet film also optionally has a top surface and/or bottom surface that will accept permanent and/or temporary highlighting markings by use of a kit pen optionally used to optically accentuate clear, colored, clear-colored, clear-colorless highlighting sheet film with erasable feature. Flat, flat-foldable film and pre-folded highlighting sheet film models allow the user to create and utilize instant tab features for quick for quick and convenient indexing. Further, low-tack, very-low tack and/or light adhesive self-adhering sheet film will form a secure seal and can be used to extend beyond the perimeter of a substrate, or overlap it, forming a tab that may also function as a bookmark for identifying pages of particular interest as well as allows end user to custom form for user need and application. Low-tack, very-low tack and/or light adhesive hereinafter may simply be referred to by the term ‘adhesive’ or ‘light adhesive, unless otherwise specifically mentioned.

The adhesive means used for attachment would provide secure temporary or long term affixation and can be applied to one or both opposing sides of the film and may be removed and reapplied one or more times without damage to the substrate to which it is applied. Virtually instant and complete adhesion of the present invention during application to an intended surface makes that surface immediately available for use. There is no curing time and its very low tack adhesive makes hand manipulation of long pieces manageable. Mounting means for the sheets in the present invention used to attach them to the surfaces they intend to highlight can include very low tack adhesive, electrostatic means and/or folded engagement around a page, a tucked configuration involving the binding edge of the page it surrounds, and creasing and/or folding and may be sealed on one or two sides as to form a pocket or a combination thereof, with additional features such as but not limited to punched holes to achieve its highlighting function without any visible alteration or devaluation of the vast majority of substrates to which it is applied. It is readily usable on paper, as well as a variety of other surfaces to include but not be limited to books and art, and it does not have any of the prior art disadvantages noted above. No existing product is known to have the same features or highlighting capabilities as the present invention.

Adhesive may be direct coated applied to present invention film and/or liner, indirect coated by coating to liner then laminated to film, zone coated whereby targeted adhesion areas are partially coated, or fully coated covering the entire surface of the film or liner for optimal usage of film and liner for minimal to no waste. Although not primary, the present invention sheet film may have such adhering means on one or both sides to allow them to be inserted in-between or around one or more two transparent or translucent surfaces so as to accentuate and/or adhere such surfaces together to accentuate a portion or all of them. Further, present invention adhesive areas may be configured with release liner in strip form that may be peeled strategic areas or zones to allow release or two or more film pieces to accommodate other sized substrates using the same piece of film, and/or the present invention may include the option of fully coating the surface of the film. However, it is preferable to limit the surface areas of adhesive by adhesive for greater diversity in the number of potential uses, ease of application, and longer life of the film and the substrate to which it is applied. In addition it is contemplated for the present invention to provide pre-scored film pieces joined together by strip lining that when folded is usable in larger format. The scored, perforated and/or otherwise sectioned highlighting sheet film remains intact until optionally strip lining is peeled away to separate two or more pre-scored, perforated, and/or pre-cut film pieces for alternate sizing and uses for user convenience. Adhesive means may be applied to fully or partially coat sheet film. Film models can be provided free of adhesive, zone coated whereby specific areas receive adhesive coating and other areas remain free from adhesive, and/or can be fully coated by direct and indirect coating application methods. Manufacturing methods providing films forms of adhesion are not limited to direct coating and/or to release liner or laminated to the film. Alternatively, direct coated highlighting sheet film without a release liner may be manufactured self-adhering individually sheeted or placed on a roll pre-sized or continuous directly layered or interleaving.

The sheet film of the present invention may be left on most surfaces indefinitely and is easily, effectively, and completely removed from most surfaces without damaging them, without making any visible alteration thereto, without permanently altering the integrity of, without leaving a colored impression or indentation, and without devaluing the surface of the substance/material to which it had been applied, even when it is left in its usable position for a very long time. Thus, it is contemplated for the time period during which the highlighting sheet film of the present invention is used to be short, such as but not limited to a few minutes of a day, or very long, such as but not limited to years, decades, or centuries. Even after an extended period of time, it is expected for the present invention, particularly its no-tack, and/or electrostatic embodiments, to be removable without any damage or visible alteration to the underlying substrate. However, once present invention sheet film is removed from a substrate, it may be stored for future referencing by the author, and/or passed on to others who share the same documentation or subject matter. In contrast to conventional highlighting methods using markers applied directly to book pages and/or other items, the highlighting provided by the present invention protects the substrate while in it's usable position and additionally optionally offers the convenience of a handheld marking instrument compatible with the surface of the film, once film is removed from the substrate targeted for highlighting becomes cryptic and private once it is removed. Reapplication of a piece of present invention sheet film over the subject matter targeted for highlighting allows the highlighted markings to again be revealed and be reviewed. In the alternative, instead of immediate reapplication without alteration, any piece of present invention sheet film may be subdivided, or otherwise prepared for reuse in the same or for a similar application, and/or reconfigured for a different application, or it may be discarded and never reused.

A variety of dispensing sizes and configurations for the present invention removable highlighter is contemplated for user convenience, which can include but is not limited to sheets of various sizes with or without a protective backing, a loose collection of individual strips or sheets having similar or different sizes that may be packaged together for sale, a continuous length of strips or sheets that is fan-folded or coiled for dispensing from a box or other package/container, electrostatically charged sheets or strips directly stacked with a backing or other material between adjacent pieces, dispensing rolls of various width and lengths used for both the strips and larger sheets, pre-sized strips without a backing, that can be separated prior to use into smaller segments via pre-cut, pre-scored, perforated, and/or pre-sectioned markings with strip lining or without strip lining, sheets that can be cut into smaller pieces for specific applications, and strips and sheets with very low tack adhesive only on one of its sides that are stacked, or in the alternative, stored in multiple layers with the tacky sides of two adjacent sheets facing one another whereby dispensing causes the user to dispense two similarly sized pieces of the present invention at a time each of which would be available for use after it is peeled from its mate.

The present invention highlighting sheet film can be dispensed in many sizes and configurations for user convenience, with virtually instant and complete adhesion, which could include but is not limited to sheets of various sizes with or without protective backing, a loose collection of individual strips or sheets, flat, flat-folded and pocketed models having similar or different sizes that may be packaged together for sale. Dispensing can also be in pre-sized units or continuous sheet, strip on a roll, the length of which is determined by the user/end consumer and/or pre-scored, and/or perforated, pre-folded film pieces in sheet, strip, and pre-pocketed forms that may be used in its entirety and may further be sized by the user, as well as pre-scored and/or perforated or not with sheets being manufactured to cover large areas than would typically be covered by a strip. Dispensing of present invention highlighting sheet film is also contemplated as a continuous sheet on a roll, and/or fan-folded, or coiled from a dispensing from a box or packaged container, tube core, or handheld or tabletop dispenser, stacked, electrostatic ally charged with backing separated by interleaving between adjacent pieces that helps preserve electrostatic charge, during storage and/or dispensing stored film. Further, two sheets may be dispensed at one time and/or variety pack attached to, removed from, and reattached to a release liner on one or two sides sheet and/or strip and is made in the form of pre-sized or continuous strip dispensed from a roll, a box, or other package/container, as well as strips attached to a backing/liner, a loose collection of individual strips and/or sheet film models having similar or different sizes that are packaged together for sale, or made a temporary part thereof until it is separated for use, and also sheets that may be cut and sized according to need of end user. Irrespective of the form in which it is used, the present invention always remains non-toxic, and easy-to-apply-and-remove. It would also remain reusable until the electro-static charge or very low tack adhesive is spent, then, the source of adhesion would have to be renewed, or the sheet film is discarded and replaced by a substitute present invention sheet film if additional highlighting is required.

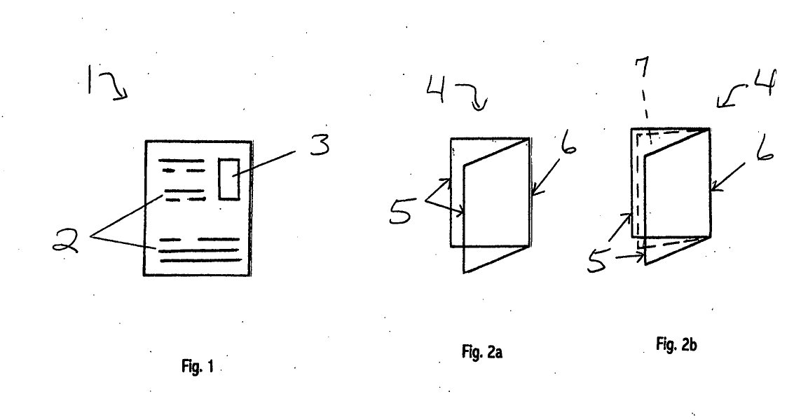

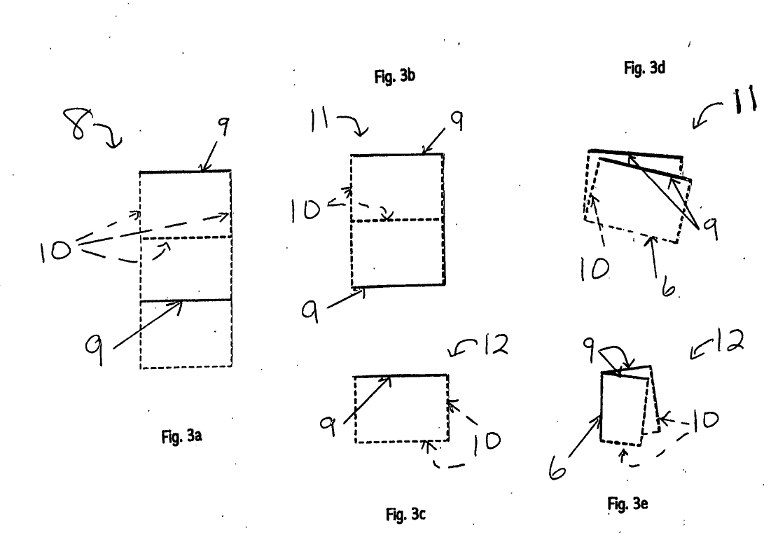

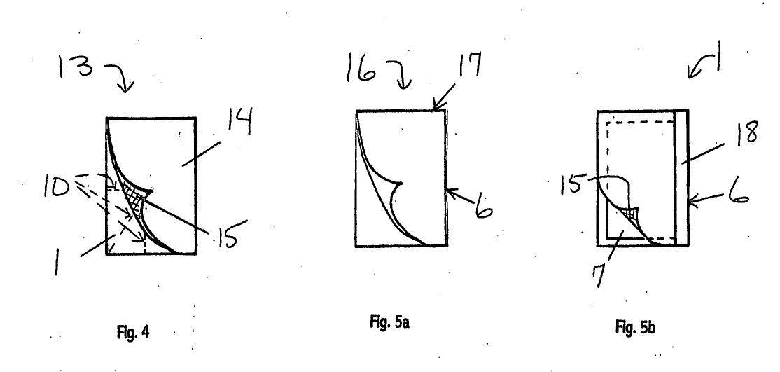

FIG. 1 is a top view of a preferred embodiment of the present invention showing a single piece of approximately 8⅜″×10¾″ transparent colored erasable highlighting sheet film 1 that displays marked lines made by use of a kit pen (not shown) which can highlight sentences 2, may be drawn across the surface of sheet film 1 to cover text, and/or outline a pictorial 3, found on a page in a book or another substrate, so that when the sheet film 1 of the present invention overlays the text 2 and/or pictorials 3 to which the marked lines 2 originally apply, it accentuates certain areas of the underlying page or substrate to make the page/substrate optically noticeable to the viewer (not shown), and when sheet film 1 is removed from the substrate, the markings made over text 2 and pictorial 3 have no attached substrate reference, and therefore no meaning, to a viewer of the highlighting sheet film 1 once removed, and as a result, the privacy of what the accentuation represents is preserved until replaced upon the substrate to which highlighting sheet film 1 and/or a second layer/level/echelon of markings thereon correspond. In the alternative, highlighting sheet film 1 may block marked lines 2 and 3 to make the remainder of the substrate to which it is attached appear accentuated. Although the piece of sheet film 1 in FIG. 1 is contemplated to be slightly smaller than standard letter size dimensions, the length, width, and thickness dimensions of sheet film 1 are limited only by the intended application and the ability of the user to handle it and apply it in the desired location of use. Therefore, highlighting sheet film 1 can be applied to a small book page or a large industrial sign with equal effectiveness in its optical enhancement. Although, however, it is also intended to provide the user sheet film models engineered to fit popular size substrates including but not limited to 3½″×5″, 4″×6″, 4″×7″, 5″×5″, 5″×7″, 5″×8″, 5½×7¾″5½″×8½″, 6½″×9½″, 7″×9″, 7″×9½″, 7″×10″, 7¼″×10″, 8″×10″, 8½″×11″, 9″×10″, 9″×12″, 11″×14″ and 11″×17″ paper-stock as well as additional sizes derived by methods of the erasable highlighting film system. Highlighting sheet film 1 sized slightly smaller than standard popular sized stock printed materials may be sized to cover printed area only for applications such as but not limited to printed areas within margins to allow pre-sized sheet film 1 pieces to fit a variety of alternate and popular sized substrates. It is determined for the present invention highlighting sheet film 1 to provide flat, flat-foldable, flat folded and pre-pocketed film models that are adaptable by pre-scoring and other methods of pre-sizing to fit more than one standard and popular size substrate or printed text area, therefore present invention sheet film 1 models may be applied to a variety, more than one, popular size substrate for example such as but not limited to page measuring 8½″×11″ whose printed area may be surrounded by an unprinted area known as a margin which may vary in size ¼″ to ¾″ may not require highlighting may be sized 8⅜″×10¾″ and will also cover but not limited to 9″×11″ and 9″×12″ highlighting printed areas with the exclusion of margins. Therefore, applications for sized highlighting sheet film 1 may include printed text on a page only, or printed area including margin area found surrounding a printed page to be made from one single sized piece of highlighting sheet film 1. Further, pre-sized highlighting sheet_film 1, for example but not limited to 8⅜″×10¾″ sheet film 1, may be used to cover said standard popular size 8½″×11″ printed area only, as well as substrates that also measures 8⅜″×10¾″ or smaller covering area with and without margins and/or may be folded by enwrapping excess highlighting sheet film 1 around a substrate, and/or pre-sectioning highlighting sheet film 1 by scored lines similar to 9 and perforated lines 10 shown in FIGS. 3a-3e may be break-away or may be cut to fit other sized substrates with a single piece of highlighting sheet film 1. In addition, highlighting sheet film 1 may be used in its entirety as shown in FIG. 1 and folded as shown in FIG. 2, and/or highlighting sheet film 1 may be scored as shown in FIG. 3 and/or perforated 10, have a release lining as shown in FIG. 4, comprise release lining, strip-lined be slit and/or scored and/or perforated or otherwise sectioned and strip-lined break-away models (not shown) separated by peeling for easy separation of film pieces held together by strips that may easily be peeled for release of one or multiple pieces of highlighting sheet film and/or separated into smaller pieces by tearing with perforated strip-lined film pieces optionally utilized to cover smaller substrates or alternately combined to achieve coverage larger than provided by a single piece of sheet film 1. Further, although not shown, highlighting sheet film 1 may be packaged larger than individually sheeted film models by fan-folding, or may be taken from a continuous roll, and/or individual portions of highlighting sheet film 1 may be pieced together parallel and/or perpendicular to one another and/or may be overlapped while maintaining visual clarity to accentuate or highlight larger areas or substrates.

The highlighting sheet film 1 of the present invention may be removed from substrate 7 and reused in its entirety and/or subdivided into smaller pieces by folding as shown in FIG. 2a to cover two opposing sides of one single bound, unbound page FIG. 2b, or may be used to highlight multiple pages and that may be grouped or identified by colored sheet film 1. In addition the highlighting sheet film 1 of the present invention may be pre-sectioned, and breakaway from a larger present invention sheet film 1 template (not shown) and/or release liner that provides the user with a method for sheet film sizing and use. In addition user may further sub-divide 8⅜″×10¾″ sheet film 1 for example in half across the length to yield two film pieces that may be used to cover two 4 3/16″×10¾″ that may be utilized to highlight a printed 3⅝″ column width found on a standard printed 8½″×11″ text page but not limited to text book, or by di-sectioning film 1 across the width in half would yield two 8⅜″×5⅜″ areas and further and/or by sectioning film both vertically and horizontally would yield approximately four 4 3/16″×5⅜″ film pieces highlighting sheet film pieces measuring approximately four and may be used to highlight areas up to and including 4 3/16″×5⅜″. In addition user may further sub-divide 8⅜″33 10¾″ sheet film 1 for example in half across the length to yield two film pieces that my be used to cover two 4 3/16″33 10¾″ that may be utilized to highlight a printed 3⅝″ column width found on a standard but not limited to 8½″×11″ text book for example, or by di-sectioning film 1 across the width in half would yield two 8⅜″×5⅜″ areas and/or by sectioning film both vertically and horizontally would yield approximately four highlighting sheet film pieces measuring approximately four 4 3/16″×5⅜″ and may be used to highlight areas up to and including 4 3/16″×5⅜″. In the alternative, instead of being contained within the perimeter of a page, sheet film 1 may be folded over the edge of a page 2b or even extend beyond the page perimeter to form a strip tab 18, as shown in FIG. 5b. identifying areas or sections of significant interest instantly. Although application of colorless and pre-colored films are provided and each are applied similarly however each film, film model, and film application offer distinct advantages to be determined by user application for intended purpose. Pre-colored film is provided to accentuate or highlight entire page 1 or multiple pages and sections in book form and non-book form and of printed or non-printed material at one time instantly while simultaneously offering the advantage of color, and optionally to offer an instant indexing system and further, film may be identified by applied markings by optional use of a kit pen by marking the substrate for example by number allows the user to associate the film once removed from location. However, by providing the option of pre-sized, pre-sectioned erasable highlighting film to form geometric shapes, strips and blocks of film, but not limited to these, allows custom sizing for example single words and/or linear lines that may follow along the form of a printed sentence in book or on a sign, a die cut or kiss cut pre-sized pre-formed sheet film to fit a paragraph or column width, may be applied for highlighting printed text, but not limited to or by these methods of/or application. Sheet film 1 is provided optional use of a kit pen for sheet film 1 pre-colored film and/or the marking instrument whose method of contrasting the film by applied marking compatible with the surface of the sheet film herein after known as a kit pen (not shown) optionally allows user to further contrast pre-colored film models.

Also, sheet film 1 may be placed vertically across a page 7 targeted for highlighting, or alternatively across the width of a bound or unbound substrate, such as but not limited to page 7. In addition, sheet film 1 may be folded and used or re-used in a flat folded configuration. Larger areas to be covered may be also be configured by placing two or more pieces of sheet film together or adjacent, parallel and/or perpendicular to one another to extend the coverage for highlighting a substrate larger than a standard sheet film shown in FIG. 1 and one that may be provided in a standard and popular size film package used to coverage in standard text in a book page, or other substrate such as use on a map to mark the best travel route to a destination and later replaced by the same sheet film 1 or another piece of sheet film 1 marked to indicate a travel route to a new destination or according to user need. Markings 2 and 3 in FIG. 1 may be left on the substrate or may be lifted and/or removed, saved, stored, and reapplied for future referencing, or markings cleaned and film reused or disposed.

FIGS. 2a and 2b both represent the same preferred embodiment of the present invention comprising a 8⅜″×10¾″ piece of folded sheet film 4 with the folded edge of sheet film designated by the number 6 and its non-folded edges substantially parallel to fold line 6 and designated by the numbers 5 representing the open ends of sheet film. In addition, FIG. 2b shows a page 7 targeted for highlighting inserted between the folded halves 5 of the clear-colorless or otherwise optically noticeable self-adhering erasable highlighting folded sheet film 4 by wrapping and/or tucking folded side 6 around page 7, and alternatively open ends 5 tucked interiorly along the binding side or edge of a book or binder (not shown). Film 4 may be rotated 90π to serve as an over-lay to cover a substrate that measures approximately 8″×5″. While folded film 4 protects and prepares two opposing sides of a single page 7 for highlighting, adhesive side covering two opposing sides of page 7, alternatively film 4 may be reconfigured to cover two adjacent or parallel pages (not shown) separated by a binding or fold with same said sheet film 4 by counter folding or reverse creasing folded side 6 and placing folded side 6 in-between adjoining pages that may be separated by a binding for example in a book or binder with open ends 5 facing outward toward the perimeter of a page (not shown), and may be placed vertically for example over a calendar pages that may hang on a wall however not limited by these examples. Although FIGS. 2a and 2b show the opposing sides of folded sheet film 4 substantially uniform is size and configuration, such uniformity is not critical. Additionally it is also intended that folded film 4 with folded edge 6 be to function as peel and release or break-away pre-sectioned film pieces by pre-sectioning by scoring, slitting, perforating along fold 6 (not shown) and separated by peeling away pre-scored and slit, and/or by tearing or cutting perforated and/or break-away pre-sectioned film pieces supply the user a variety of alternate sheet film sizes to be configured from a single unified piece of sheet film. This feature is provided for versatility and utility of sheet film and added convenience and no waste concept. In addition to providing user with option of holding two or more film pieces together enabling the user to create a variety of alternate sizing instantly by peeling liner and/or other materials such as but not limited to film strips by peeling away from its backing strip liner once peeled may be recycled by the user to highlight portions of material desired to be accentuated or blocked out for example during photocopying. Erasable highlighting film may be photocopied with substrate still attached and is made invisible by photocopying, and alternately and optionally self-adhered opaque lining may be used to block unwanted portions of text and other subject matter.

FIGS. 3a-3e show how a piece of present invention sheet film 8, 11, and 12 may be subdivided and/or folded prior to use for custom sizing and application. FIGS. 3b-3e show how present invention sheet film 8 may be further subdivided by separating pre-sectioned scored 9 and perforated 10 cut lines provide standard popular or commonly sized flat sheet film models once separated and or folded along scored line 9 or perforated line 10 by the user supplied application methods by scoring lines 9 and perforated markings 10 optionally provide method to achieve smaller pre-sectioned sheet film pieces for custom sizing and application, whereby, as one example, sheet film 11 approximately 11″×17″ and, sheet film 12 in FIG. 3c are sized to fit an 8½″×11″ substrate both may be used in their entirety and/or further folded or subdivided to yield smaller sizes shown in FIG. 3d and further as sized as shown in sheet film 12 in FIG. 3e. FIG. 3a is a top view of a preferred embodiment of a piece of visually transparent clear-colorless present invention sheet film 8 approximately 10¾″×26¼ sized to fit three 8½″×11″ or one 11″×17″ and one 8½×11″ substrate having pre-scored lines 9 and perforated lines 10 via adhering means not visible in FIG. 3a and pre-applied during manufacture and or applied to sheet film 8 by the user prior to its association with a substrate for accenting and highlighting purposes, sheet film 8 can be applied by the user to a substrate in its entirety or in smaller flat and flat folded configurations, such as illustrated in FIGS. 3b-3e but not limited to flat configuration therefore and further may be sectioned and/or configured into other dimensional film models. Sheet film 8 can be further subdivided by cutting in areas not having pre-scored lines or perforated lines.

FIG. 3b shows a first subdivided piece of the sheet film 11, sized to fit 11″×17″ approximately 10¾″×16¾″ in dimension taken from the sheet film 8 shown in FIG. 3a via separation at the lower pre-scored line 9. Sheet film 11 can be applied by a user for highlighting purposes in its entirety or in smaller flat and flat folded configurations, such as illustrated in FIGS. 3c-3e. FIG. 3c is a top view of a preferred embodiment of a piece of visually transparent clear-colorless present invention sheet film that is further separated from a dimensionally larger pre-scored and perforated sheet for custom sizing, which can then be applied by the user in its entirety, in smaller flat configurations, or the folded configuration illustrated in FIG. 3e. FIG. 3d is a perspective view of a preferred embodiment of a piece of visually transparent clear-colorless present invention sheet film that is separated from the dimensionally larger pre-scored and perforated sheet shown in FIG. 3a for custom sizing, and which is folded prior to being applied by a user to a substrate instead of being used flat as shown in FIG. 3b. FIG. 3e is a perspective view of a preferred embodiment of a piece of visually transparent clear-colorless present invention sheet film that is separated from the dimensionally larger pre-scored and perforated sheet shown in FIG. 3b for custom sizing, and which is folded prior to being applied by a user to a substrate instead of being used flat as shown in FIG. 3c.

Alternately pre-sectioned sheet film 8 FIGS. 3a-3e may also be strip-lined in strategic areas single or double-sided, adhesive backed film strips adding adhesion where minimal tack to the substrate is desired but enough to secure film model to the substrate to be accentuated or highlighted, and when removed separate sheet film one from the other or used again to hold film pieces together until user optionally chooses to separate them again for the same or alternate applications when applicable for example but not limited to pre-scored lines 9, and perforated lines 10 may be provided with release lining in the form of a sheet fully lined FIG. 4 or strip release lined (not shown) adhesive backed 15 as shown in FIG. 4 sheet film 1 once separated from its backing 14 from may be see-through or opaque utilized to highlight by contrasting or block-out respectively underlying portions of an associated substrate for highlighting areas surrounding said film. Further full sheets of film and/or liner may be paced adjacent to one another and stacked and peeled away.

FIG. 4 shows a single sheet of present invention transparent colored sheet film placed onto a release liner between uses. Sheet film placed onto release lining may dispensed in sheets and may be sectioned or pre-sectioned, pre-scored across its width and/or length, and/or diagonally to form break-away geometric shapes, strips and blocks as shown in FIG. 4 yielding smaller pieces for alternate size substrates and particularly for pre-colored film for applications without use of a kit pen for custom highlighting applications and user convenience word, lines and in sentences or whole paragraphs, column width front and back. Film may be pre-sized, fan-folded, and/or may be continuous, or cut into strips and/or may be packaged loosely, either configuration may be peeled from the applied backing separating it from another sheet or sandwiched between adjacent layers of the present invention that preserves the adhesive means 15 on liner/backing 14 or renews the electrostatic charge on the sheet film 1, or by peeling it from its paired mate when two or more present invention sheet film and/or liner 14, each with very low tack adhesive only on one of its sides, are stored in pairs with the tacky sides of two adjacent sheets facing one another whereby dispensing pre-sized individual sheets via fan-folding or otherwise dispensed would cause the user to dispense two or more similarly sized pieces of the present invention at once. Present invention may be removed and re-applied to the intended substrate that requires accenting or highlighting one or multiple times, and repeatedly re-used until the adhesion layer very low tack adhesive or electro-static charge wears out or may optionally be renewed by adhesion application methods provided by the manufacturer used in same or similar application and/or reconfigured for another or different application or may be discarded by the user. Film and/or lining may be clear-colorless, colored, transparent or translucent, or opaque, double-sided, adhesive backed or not, or separated by interleaving, liners may be provided pre-printed to show visual sizing of film pieces and may be used to reattach film to liner, printed and coated with varying adhesive tack insofar as the liner when peeled away from the liner adhesive means remains on each coated surface, therefore making usable the film and the liner for accenting or highlighting functions or purposes therefore no waste. Use of the present invention film to secure at least two colored transparent sheets together to vary the color of the light passing collectively through all or part of them. Additionally film 1 and/or liner 14 illustrate adhesion area 15 on liner 14 interiorly facing sheet film 1 and is provided fully coated, and partially coated by the manufacturer and or applied by user prior to application. Adhesive may be directly applied to film and/or liner, indirectly to liner then laminated to film, zone coated whereby targeted adhesion areas are partially coated, and fully coated covering the entire surface of the film and/or liner for optimal usage of film and liner for minimal to no waste. The present invention sheet films may have such adhering means on one or both sides to allow them to be inserted in-between or around one or more two transparent or translucent surfaces so as to accentuate and/or adhere such surfaces together to accentuate a portion or all of them. Area 15 may be provided pre-cut not limited to rotary die-cut kiss cut corners for easy peel and release attachment and removal and re-application and also to provide release-lined strips in strategic areas on 15 for minimal tack advantages. FIG. 4 film 1 liner 14 may be peeled away from film 1 and may be replaced onto the liner 14 for storage until needed for reuse. Additionally film may be folded adhesive side toward the substrate as shown in FIG. 2b to cover two opposing sides of a single page with ends 5 tucked into or toward a binding edge and laid across a bound or unbound page for example in a book or a ringed binder, and/or alternatively, folded sheet film 4 may be reconfigured by reverse creasing/folding placing films adhesion layer toward the substrate to be highlighted across one or more parallel, perpendicular or adjacent pages or other substrate (not shown) and inserting or tucking sheet film folded side 6 into the binding edge between pages for example in an opened book, or a ringed binder and may be closed and preserved to the substrate for future referencing without damage to the substrate. Additionally/Optionally holes may be punched for secure affixation in ringed binders particularly where no-tack electro-static film models are used, excess film and may optionally cut and may staggered and/or be written upon tab 18 or marked by use of kit pen (not shown) remain affixed temporarily or permanently and or removed from the surface of the film and may be cleaned and re-written upon. Optionally, a strip of paper or other form may be pre-written upon to be inserted in-between folded film tab 18 before it is sealed, and may be removed by peeling film away from the page 7 or substrate and removed or replaced. Pre-colored, and clear-colored films may be used for added identification instantly with optional use of kit pen.

FIGS. 5a and 5b show a piece of present invention sheet film prepared for enwrapping both sides of a flattened substrate, such as but not limited to the page 7 targeted for highlighting shown in FIG. 5b. FIG. 5a shows a pre-pocketed preferred means of utilizing sheet film embodiment 16 of the present invention made from self-adhering pre-colored highlighting sheet film having a sealed top 17 and side 6. In the alternative, the top of the highlighting film in pre-pocketed preferred embodiment 16 could be folded and folded side 6 sealed, or top 17 and folded side 6 sealed via adhesive only, adhesive and/or sealing by heat, pressure or by any other means and method of providing closed end used to wrap or secure film to the targeted substrate 7 as shown in FIG. 5b. It is intended that areas of film surfaces to be optionally adhered for maximum security of film affixation to substrate however adhesive areas may be configured with release liner in strip form or sheet form or not. It is however preferable to limit the surface area of adhesive when used and placement is reserved for strategic locations to allow partial areas of the film to remain uncoated for easy release and minimal adhesion to a substrate and for alternative applications. In contrast, FIG. 5b shows a representation of present invention self-adhering pre-colored highlighting sheet film 1 folded in half forming a strip tab 18 along the outside perimeter of an unbound page 7 targeted for highlighting with an adhesion side 15 facing interiorly toward the top surface of unbound page 7. Thus, by way of example, when film 1 is applied to a page in a book (not shown), strip tab 18 draws attention to the location of the page 7 it enwraps relative to adjacent book pages that are not intended for additional viewer reading or study, as well as provides a means for highlighting and thereby drawing attention to selected information and/or illustrations on one or both sides of page 7. When tab 18 is configured to run along the outer perimeter of the page 7, it remains in place or is removed depending on user need/application film may optionally be marked for identification of content and/or by page number for quick referencing and/or labeling by use of a kit pen. At a later time, film 1 can be removed from page 7, and the book loaned to another reader while the highlighted areas remain private. When the book is returned, its owner can again replace film 1 with its highlighting notes, if needed, clean film 1 to remove any highlighting notes and place film 1 over page 7 for the addition of updated highlighting notes, film 1 may be discarded, and/or film 1 may be cleaned and/or reconfigured such as but not limited to subdivided into smaller pieces for use on page 7 or another substrate (not shown). When multiple strip tabs 18 are used, they can be differentiated by color, or not. Optionally a strip of paper or other writable surface forms may be pre-written upon to be inserted in-between folded film tab 18 (not shown) before it is sealed, and may be removed by peeling film 1 away from the page 7 and removed or replaced. Pre-colored, and clear-colored films may be used for added identification instantly with optional use of kit pen. The description herein is preferred embodiments and should not be construed as limiting the scope of the present invention.

The invention provides users with erasable highlighting sheet film, such as but not limited to the piece of sheet film 1 shown in FIG. 1. However, the invention also provides a method and apparatus for erasable highlighting sheet film whose component forms include transparent and translucent visually clear, colored, clear-colored, and clear-colorless highlighting sheet film, removable adhesion means for the sheet film that allows it to preserve and protect handwritten highlighted markings and the substrate it covers, at least one cloth adapted for cleaning/preparing sheet film to include erasure of markings and generating electro-static charge, and at least one kit pen used for erasably marking the sheet film in kit form. It is a primary object of the present invention to provide/offer users a variety of sheet film and sheet film options, such as that of visually and/or optically clear transparent erasable highlighting film substances; visually clear and/or optically clear erasable highlighting film substances; translucent and other erasable highlighting film substances; and provide/offer erasable highlighting sheet film with the qualities of visually and/or optically clear transparent and translucent clear, colored, clear-colored, clear-colorless; film with erasable highlighting feature and further to provide a variety of film models in sheet/strip/pocket form, in pre-sized, pre-sectioned, pre-scored, perforated, flat, folded, and/or flat-foldable, and pre-pocketed film models consisting of a top surface and/or bottom surface or alternately stacked with a thin film placed between or atop each surface wherein one is capable of contrasting clear, clear-colored, and clear-colorless films that may be layered with optional adhesive means placed on any or all surfaces contrasting film from film, and/or film from text, and/or text from film. Clear-colorless and colored sheet film respectively may be utilized to form instant tabs along the perimeter of a bound or unbound page by placing two or more loose sheets, and/or folded self-adhering film models, with adhesion sides together and/or tacky sides facing the substrate one it is in its usable position between the loose sheets or self-adhering film model adhesion/tacky sides, between which the substrate to be highlighted is inserted to leave a surplus portion of sheet film along one edge of the substrate so that the surplus portion of the sheet film form a tab that may be identified by color only, color and marking, color-less and/or by marking to identify preferred sections of interest selected for highlighting.

The sheet film of the present invention may be left on most surfaces indefinitely and is easily, effectively, and completely removed from most surfaces without damaging them, without making any visible alteration thereto, without permanently altering the integrity of, without leaving a colored impression or indentation, and without devaluing the surface of the substance/material to which it had been applied, even when it is left in its usable position for a very long time. Thus, it is contemplated for the time period during which the highlighting sheet film of the present invention is used to be short, such as but not limited to a few minutes of a day, or it very long, such as but not limited to years, decades, or centuries. Even after an extended period of time, it is expected for the present invention, particularly its no-tack, and/or electrostatic embodiments, to be removable without any damage or visible alteration to the underlying substrate. However, once present invention sheet film is removed from a substrate, it may be stored for future referencing by the author, and/or passed on to others who share the same documentation or subject matter. In contrast to highlighting applied directly to book pages and/or other items, the highlighting provided by the present invention becomes cryptic and private once it is removed. Reapplication of a piece of present invention sheet film over the subject matter targeted for highlighting allows the highlighted markings to again make sense and be reviewed. In the alternative, instead of immediate reapplication without alteration, any piece of present invention sheet film may be cleaned, subdivided, and/or otherwise prepared for reuse in the same or a similar application, and/or reconfigured for a different application, or it may be discarded and never reused.

Options for sheet film 1 reconfiguration for varied applications include but are not limited to reverse creasing folded and pocket models, such as but not limited to pre-pocketed preferred embodiment 16 in FIG. 5a, to fit two self-facing parallel surfaces. Also, colored sheet film 1 can be used for accentuating or highlighting purposes with or without added marking from a kit pen (not shown). However, the present invention offers a user the advantage of highlighting an entire page 7 of interest instantly with one piece of sheet film 1, with an option to provide a second layer/level/echelon of highlighting through use of a kit pen. All colored sheet film 1 allows the user to accentuate or highlight a large section of printed and unprinted material in one application quickly and efficiently. Both colored and colorless film models by use of the kit pen allow the user to the ability to efficiently highlight fewer and selected areas such as one word efficiently and in one stroke and without damage to the substrate to which they are applied. More sheet film options include the use of sizing templates, cutting instruments, pre-folded sheet film or sheet film folded by the user, stacked sheet film, sheet film taken from a roll such as one having a core tube, sheet film dispensing via a hand-held or table-top dispenser that provides cutting or tearing to size after extension of a length needed for use, continuous dispensing to provide a length and width dimension sufficiently large for industrial use such as but not limited to the marking of a sign to accentuate a portion or all of it, as well as accentuate walls, floors, painted surfaces, glass, plastic, vinyl, and paper. Thus, in addition to applications that include dispensing of various widths and lengths of sheet film from one or more rolls, dispensing subdivided portions or strips of sheet film, the use of pocketed sheet film models, the use of oversized pieces of sheet film for industrial and other uses, and the use of pre-sized pieces of sheet film, the present invention provides sheet film with and without a backing that may or may not be dispensed on a sizing template, without or as a release liner that may be adapted for use and/or used as a template for sizing, and further may be used for storage of used and unused sheet film. Alternatives for dispensing/storing sheet film can be from a roll whereby ultimate length of the sheet film used if determined by the user, or in a flat configuration, such as but not limited to a fan-folded configuration.

I claim:

1. A reusable removable highlighting system for short term and long term use that is configured for providing a visually noticeable accent to the substrate with which it is associated, said highlighter comprising:
at least one piece of flexible and optically noticeable sheet film; and
adhesion means associated with said sheet film that is adapted for placing said sheet film in fixed association with a substrate for sheet film accentuation of at least one portion of the substrate, and also further adapted for subsequently allowing said sheet film to be readily removed from that substrate without any visibly noticeable damage to the substrate and thereafter be available for optional resizing and optional reapplication in the same size or a new size or sizes, to the same location or a new location or locations, on the same or a new substrate or substrates, said sheet film adapted for providing a first level of highlighting and also being capable of accepting a second level of highlighting removable at any time by the user.

2. The highlighter of claim 1 wherein said sheet film is selected from a group consisting of film pre-sectioned into individually usable sheets, pre-formed sheet film, sheet film lined with liner, opaque sheet film, light-transmitting sheet film, coated sheet film, self-facing sheet film, electrostatically charged sheet film, wiped sheet film, sheet film attachable to glass, sheet film attachable to paper, sheet film attachable to stone, sheet film attachable to metal, sheet film attachable to cloth, sheet film attachable to plastic, sheet film attachable to vinyl, sheet film attachable to wood, sheet film attachable to steel, sheet film attachable to concrete, sheet film attachable to porcelain, sheet film attachable to imitation substances, sheet film attachable to composites, sheet film configured to peel off in strips, sheet film configured to break away into two or more sections, sheet film configured for reuse multiple times, sheet film that can be rolled, flattened sheet film, heat sealed sheet film, stamped sheet film, cleaned sheet film, reconfigured sheet film, self adhering sheet film, sheet film configured to be separated by tearing, pre-cut sheet film, sliced sheet film, pre-scored sheet film, perforated sheet film, scored and perforated sheet film, continuous sheet film without perforations and pre-scoring, strip-lined sheet film, slit and strip-lined sheet film, perforated and scored with strip lining, flat sheet film, folded sheet film, foldable sheet film, folded and perforated sheet film, cut and folded sheet film, flat-foldable sheet film, sealed sheet film, sheet film closed on at least one end, sheet film sealed to provide at least one closed end so as to form a pocket, folded and sealed sheet film, folded and sealed sheet film configured with sealing capable of being peeled open and used flat, folded and sealed sheet film configured with sealing capable of being peeled open and reconfigured, folded and sealed sheet film configured with sealing capable of being peeled open for reverse folding and creasing, transparent sheet film, translucent sheet film, pH balanced sheet film, sheet film having pH balanced light adhesive, pH neutral sheet film, sheet film having pH neutral light adhesive, sheet film that is invisible when photocopied, sheet film that retains its highlighting capability on photocopies, sheet film having dark colors that visibly block out underlying portions of an associated substrate for highlighting areas surrounding the blocked out portions, opaque sheet film that blocks out underlying portions of an associated substrate for highlighting areas surrounding the blocked out portions, film with erasable quality, film with heat resistant capability, film with visualization enhancements, colored sheet film, sheet film with increased magnification, sheet film with decreased magnification, sheet film with visual enhancements, color sheet film, clear colored sheet film, clear colorless sheet film, sheet film exhibiting color contrast in response to applied pressure, sheet film exhibiting visual change in response to applied pressure, sheet film with light reflecting capability, sheet film with light absorbing capability, sheet film having magnification capability, polarized sheet film, sheet film with UV capability, film with directional properties, sheet film capable of alternative multiple forms, sheet film in single layers solely providing contrast from an associated substrate, sheet film when used in single layers providing contrast with an associated substrate and providing additional visual change in further contrast with original sheet film and substrate structure, sheet film when used in multiple layers providing additional visual change in contrast with original sheet film and substrate structure, fan-folded sheet film, sheet film configured for dispensing from a stack, and sheet film configured for dispensing from a roll, qualities of visually clear, quality of optically clear, surface coatable wet, surface coatable dry, surface capable of being glued, capable of being etched, capable of temporary attachment, capable of permanent removable attachment, capable of being coated and stacked, capable of being laminated to itself, capable of attachment to glass, capable of attachment to paper, capable of attachment to glass, capable of attachment to wood, capable of attachment to porcelain, capable of attachment to metallic substances, capable of attachment to stone, capable of attachment to vinyl, capable of attachment to concrete, capable of attachment to plastic, capable of attachment to steel, capable of attachment to

3. The highlighter of claim 1 wherein said sheet film has a top surface and a bottom surface and wherein said adhesion means for said sheet film is selected from a group consisting of very low tack adhesive applied to said top surface of said sheet film, very low tack adhesive applied to said bottom surface of said sheet film, very low tack adhesive applied to said top surface and said bottom surface of said sheet film, pressure sensitive adhesives, non-pressure sensitive adhesives, pH neutral adhesives, pH balanced adhesives, adhesives adapted so as not to accelerate the deterioration of archival materials, an electrostatic charge applied to said top surface of said sheet film, an electrostatic charge applied to said bottom surface of said sheet film, an electrostatic charge applied to said top surface and said bottom surface of said sheet film, very low tack adhesive and electrostatic charge each applied to a portion of at least one surface of said sheet film, a single adhesion layer applied on top of said sheet film, a single adhesion layer applied under said sheet film, two adhesion layers with one applied on top of and the other applied under said sheet film, a plurality of adhesion layers attached on top of said sheet film, a plurality of adhesion layers attached under said sheet film, and multiple adhesion layers with at least one of said multiple layers attached on top of and at least one of said multiple layers attached under said sheet film, adhesion means applied by the manufacturer of said sheet film, user applied adhesion means, adhesive applied by direct coating, adhesive applied by indirect coating, adhesive fully coating said sheet film, adhesive partially coating said sheet film, colored adhesive, colorless adhesive, visually clear translucent adhesive, optically clear adhesive, repositionable adhesive, pressure sensitive adhesive, pressure sensitive colored adhesive, adhesive revealing color as a result of pressure application, adhesive configured for short term temporary adhesion of said sheet film to a substrate and full removal of said sheet film without visible substrate damage, adhesive configured for long term indefinite adhesion of said sheet film to a substrate and full removal of said sheet film without visible substrate damage, no tack adhesion created by folding said sheet film around a substrate, no tack adhesion created by wrapping two pieces of said sheet film around a substrate, no tack adhesion created by folding and wrapping said sheet film around a substrate, no tack adhesion created by folding and wrapping said sheet film around a substrate and further use of punched holes through said sheet film, no tack adhesion created by wrapping and tucking said sheet film around a substrate, no tack adhesion created by folding and wrapping and said sheet film around a substrate, no tack adhesion created by tucking said sheet film into a bound edge, and further wherein the source of said electrostatic charge is selected from a group consisting of said at least one piece of sheet film being pre-manufactured to innately carry said electrostatic charge, user applied electrostatic charge, and said at least one piece of sheet film given said electrostatic charge by an independent apparatus prior to said sheet film being attached to a substrate.

4. The highlighter of claim 1 further comprising items associated with said sheet film, said items selected from a group consisting of peelable backings, cut corners providing easy release and removal of said sheet film, perforations, pre-scored markings, pre-sectioned markings, multiple pieces of said sheet film configured in self-wound dispensing rolls, multiple pieces of said sheet film configured as a part of a dispensing rolls with a tube, table-top dispensing rolls, and pull and tear dispensing rolls.

5. The highlighter of claim 4 wherein dispensing of said highlighter is selected from a group consisting of dispensing by removal of pre-cut sections of said highlighter from at least one of said peelable backings, break away, sheet lined, strip lined, dispensing of said highlighter in geometric form, dispensing of said highlighter in non-geometric form, dispensing of said highlighter in block form, dispensing of said highlighter in strip form, dispensing of said highlighter without a backing, dispensing said highlighter in the form of loose pieces of said sheet film, dispensing by separation of said highlighter at said perforations, dispensing by separation of said highlighter at said pre-scored markings, dispensing by separation of said highlighter at said pre-sectioned markings, dispensing said highlighter from said dispensing rolls in any size according to application requirements, dispensing of said highlighter from said table-top dispensing rolls in any size according to application requirements, dispensing said highlighter from said pull and tear dispensing rolls in any size according to application requirements, dispensing by custom cutting said highlighter and separation of cut portions thereof from uncut portions, dispensing pre-cut pieces of said highlighter from said dispensing rolls, dispensing pre-cut pieces of said highlighter from said pull and tear dispensing rolls, dispensing said highlighter through use of said cut corners, dispensing by direct removal of said highlighter from a layered stack, dispensing by removal of said highlighter from a layered stack comprising interleaving, dispensing by removal of said highlighter from a fan-folded continuous stack, dispensing by removal of said highlighter from a fan-folded pre-sectioned stack, dispensing by removal of said highlighter from an individually sheeted stack, dispensing by removal of said highlighter from a stack comprising removable backing, and dispensing wherein multiple pieces of said highlighter with said adhesion means in contact with one another are simultaneously dispensed.

6. The highlighter of claim 1 wherein the length of time said sheet film is placed against the substrate does not change sheet film removal capability for later removal from the substrate without damage and without visible alteration to sheet film or substrate.

7. The highlighter of claim 1 wherein said sheet film is adapted for attachment to substrates selected from a group consisting of smooth surfaces, textured surfaces, matte surfaces, glossy surfaces, paper, text in book form, binders, text in non-book form, individual pages, pages grouped in sections, pages targeted for book binding, words, entire sentences or parts thereof, paragraphs, pictorials, pictures, research material, documents, archival materials, maps, charts, calendars, catalogs, telephone books, visual display screens, display boards, artwork, signs, recipes, metallic surfaces, plastic, vinyl, glass, porcelain, cloth, wood, stone, walls, floors, painted surfaces, and powder coated surfaces.

8. The highlighter of claim 1 wherein said sheet film has a non-adhesive surface selected from a group consisting of non-adhesive surfaces adapted for receipt of hand-written markings applied at any time prior to and after application of said sheet film to a substrate, non-adhesive surfaces permitting removal of markings hand-written thereon at least once, non-adhesive surfaces capable of receiving new hand-written markings after previous hand-written markings have been removed, non-adhesive surfaces adapted for receipt of printed markings applied at any time prior to and after application of said sheet film to a substrate, non-adhesive surfaces permitting removal of markings printed thereon at least once, non-adhesive surfaces capable of receiving new printed markings after previous printed markings have been removed, adhesive surfaces permitting removal of markings, non-adhesive surfaces permitting coatings, and non-adhesive surface permitting adhesive coatings.

9. The highlighter of claim 1 further comprising other items associated with said sheet film in package form, with said items being selected from a group consisting of pieces of cloth adapted for cleaning said sheet film, pieces of cloth adapted for surface preparation of said sheet film, pieces of cloth adapted for erasure of markings applied to said sheet film, pieces of cloth adapted for giving said sheet film an electrostatic charge, sheet film cutting instruments, templates with suggested cutting patterns for maximizing use of said sheet film, templates adapted for storing new and used pieces of said sheet film, colorants, adhesives, dispensing containers, cleaning compositions, and at least one sheet film marking means comprising substances selected from a group consisting of colorants, colorless compositions, and cleaning compositions, further adapted for making temporary markings, permanent markings, colored markings, colorless markings removable markings, and erasable markings, and said marking means also adapted for removing markings.

10. A method for highlighting substrates to make them visually noticeable at a glance, said method comprising the steps of:
providing at least one flexible, and optically noticeable sheet film with adhesion means on at least one of its opposed surfaces, and a substrate with at least a portion thereof requiring highlighting accent, and wherein said adhesion means is adapted for temporary adhesion to said substrate and further adapted for being readily peeled from said substrate without any visibly noticeable damage to it, and further wherein said adhesion means is selected from a group consisting of very low tack adhesives and electrostatic charge; and
moving said sheet film forwardly against the portion of said substrate requiring highlighting accent until said adhesion means fastens said sheet film to said substrate.

11. The method of claim 10 wherein said sheet film is selected from a group consisting of sheet film in the form of sheets, sheet film configured to peel off in strips, transparent sheet film, translucent sheet film, pH balanced sheet film, sheet film having pH balanced very low tack adhesive, pH neutral sheet film, sheet film having pH neutral very low tack adhesive, sheet film that is invisible when photocopied, sheet film that retains its highlighting capability on photocopies, sheet film having dark colors that visibly block out underlying portions of an associated substrate for highlighting areas surrounding said sheet film, sheet film with optical qualities, sheet film with light reflecting capability, sheet film with light absorbing capability, sheet film having magnification capability, and polarized sheet film.

12. The method of claim 10 wherein said adhesion means is selected from a group consisting of very low tack adhesive applied to said top surface of said sheet film, very low tack adhesive applied to said bottom surface of said sheet film, very low tack adhesive applied to said top surface and said bottom surface of said sheet film, pressure sensitive adhesives, non-pressure sensitive adhesives, pH neutral adhesives, pH balanced adhesives, adhesives adapted so as not to accelerate the deterioration of archival materials, an electrostatic charge applied to said top surface of said sheet film, an electrostatic charge applied to said bottom surface of said sheet film, an electrostatic charge applied to said top surface and said bottom surface of said sheet film, very low tack adhesive and electrostatic charge applied to said top surface of said sheet film, very low tack adhesive and electrostatic charge applied to said bottom surface of said sheet film, very low tack adhesive and electrostatic charge each being applied to said top surface and said bottom surface of said sheet film, a single adhesion layer attached on top of said sheet film, a single adhesion layer attached under said sheet film, two adhesion layers with one attached on top of and the other attached under said sheet film, a plurality of adhesion layers attached on top of said sheet film, a plurality of adhesion layers attached under said sheet film, and multiple adhesion layers with at least one of said multiple layers attached on top of and at least one of said multiple layers attached under said sheet film, and further wherein the source of said electrostatic charge is selected from a group consisting of said sheet films being pre-manufactured to innately carry said electrostatic charge and sheet films given said electrostatic charge by an independent apparatus prior to said sheet film being attached to a substrate.

13. The method of claim 10 further comprising items selected from a group consisting of peelable backings, a second piece of said highlighter, pre-scored markings, dispensing rolls, and hand-held dispensing rolls, and wherein said steps of dispensing of said highlighter are selected from a group consisting of dispensing by removal of pre-cut pieces of said highlighter from at least one of said peelable backings, dispensing using a second piece of said highlighter wherein two pieces of said highlighter with said adhesion means in contact with one another are dispensed at a time, dispensing pieces of said highlighter by custom cutting and separating them from uncut portions of said highlighter, dispensing pieces of said highlighter by causing separation of said highlighter at said pre-scored markings, dispensing pieces of said highlighter from said dispensing rolls in various sizes according to application requirements, dispensing pre-cut pieces of said highlighter from said dispensing rolls, dispensing pre-cut pieces of said highlighter from said hand-held dispensing rolls, and dispensing pieces of said highlighter from said hand-held dispensing rolls in various sizes according to application requirements.

14. The method of claim 10 wherein the length of time said highlighter is placed against the substrate does not change its ability to be later removed there from without visible damage to the substrate.

15. The method of claim 10 wherein said sheet film is adapted for attachment to substrates selected from a group consisting of smooth surfaces, textured surfaces, matte surfaces, glossy surfaces, paper, text in book form, binders, text in non-book form, individual pages, pages grouped in sections, pages targeted for book binding, words, entire sentences or parts thereof, paragraphs, pictorials, pictures, research material, documents, archival materials, maps, charts, calendars, catalogs, telephone books, visual display screens, display boards, artwork, signs, recipes, metallic surfaces, plastic, vinyl, glass, porcelain, cloth, wood, stone, walls, floors, painted surfaces, and powder coated surfaces.

16. The method of claim 10 wherein said sheet film has a non-adhesive surface selected from a group consisting of non-adhesive surfaces adapted for receipt of hand-written markings applied at any time prior to and after application of said sheet film to a substrate, non-adhesive surfaces permitting removal of markings hand-written thereon at least once, and non-adhesive surfaces capable of receiving new hand-written markings after previous hand-written markings have been removed.

17. The method of claim 10 wherein said sheet film is made to have a dark color that visibly blocks out the underlying substrate to make areas surrounding said sheet film optically noticeable, allowing the areas surrounding said sheet film to be photocopied more efficiently and in less time.

18. The method of claim 10 wherein said sheet film is clear colored and visibly noticeable, said adhesion means is applied to both of said opposed surfaces of said sheet film, and said adhesion means adds no opacity to said sheet film, and further comprising the steps of providing two light-transmitting surfaces and positioning said sheet film against and between two light-transmitting surfaces so that said adhesion means on said sheet film causes both said light-transmitting surfaces to become attached to said sheet film.
